(19) United States
(12) Patent Application Publication
(10) Pub. No.: US 2024/0386512 A1
(43) Pub. Date: Nov. 21, 2024

(54) COMPUTER-IMPLEMENTED PLATFORM AND TECHNIQUES FOR REAL ESTATE

(71) Applicant: Mosaik, Inc., Orlando, FL (US)

(72) Inventor: Sheila Nanamala Reddy, Orlando, FL (US)

(21) Appl. No.: 18/667,406

(22) Filed: May 17, 2024

Related U.S. Application Data
(60) Provisional application No. 63/503,078, filed on May 18, 2023.

(51) Int. Cl. G06Q 50/163; G06F 16/9538

(52) U.S. Cl. CPC G06Q 50/163; G06F 16/9538

(57) ABSTRACT

The present teachings generally include a computer-implemented platform for real estate personnel, such as real estate agents (and organizations) and their clients. The platform may include improved searching and techniques for displaying search results, including relative importance-based searching with sophisticated filtering and weighting that can provide more pertinent, personalized, and/or comprehensive results than existing searching techniques. The platform may also or instead include workflow management tools, thus providing an all-in-one platform for real estate that includes, inter alia, transaction management, document management, scheduling, communications, task management, compliance management, templating, and so forth. The platform may also or instead include client retention tools, service prediction tools (and other prediction tools), service recommendation tools, property owner/management tools, communications tools, insight tools, and the like.

### CROSS-REFERENCE TO RELATED APPLICATIONS

This application claims priority to U.S. Provisional Patent App. No. 63/503,078 filed on May 18, 2023, the entire contents of which are hereby incorporated by reference herein.

### FIELD

The present disclosure generally relates to a computer-implemented platform for real estate personnel, such as real estate agents and their clients.

### BACKGROUND

There remains a need for improved tools and platforms for real estate personnel, such as real estate agents and their clients, for example, that provide advantageous searching, workflow management, communications, client retention tools, insights, and so forth.

### SUMMARY

The present teachings generally include a computer-implemented platform for real estate personnel, such as real estate agents (and organizations) and their clients. The platform may include improved searching and techniques for displaying search results, including relative importance-based searching with sophisticated filtering and weighting that can provide more pertinent, personalized, and/or comprehensive results than existing searching techniques. The platform may also or instead include workflow management tools, thus providing an all-in-one platform for real estate that includes, inter alia, transaction management, document management, scheduling, communications, task management, compliance management, templating, and so forth. The platform may also or instead include client retention tools, service prediction tools (and other prediction tools), service recommendation tools, property owner/management tools, communications tools, insight tools, and the like.

In an aspect, a computer program product disclosed herein may include computer executable code embodied in a non-transitory computer readable medium that, when executing on one or more computing devices, performs the steps of: receiving real estate data for a plurality of properties from one or more third-party sources of data; processing the real estate data including at least one of normalizing the real estate data and tagging the real estate data to create a property profile for each listing included in the real estate data; receiving search criteria from a user; processing the search criteria including (i) weighting at least a portion of the search criteria, and (ii) assigning a buffer threshold to at least one criterion of the search criteria; analyzing, using a model, the processed real estate data by comparing the property profiles for one or more properties to the processed search criteria; scoring one or more properties based on at least (i) a match between processed real estate data and the processed search criteria, the match at least in part accounting for the buffer threshold of the at least one criterion, and (ii) weighting of the processed search criteria; ranking one or more properties based on the scoring; and displaying, on a user interface, at least a portion of the ranking of one or more properties. Other embodiments of this aspect may include corresponding computer systems, apparatus, methods, devices, and computer programs recorded on one or more computer storage devices, each configured to perform one or more of the aforementioned steps.

Implementations may include one or more of the following features. All properties within buffer thresholds may be scored. The computer program product may include computer executable code that, when executing on the one or more computing devices, performs the step of displaying at least one listing having a parameter falling outside of the search criteria but within one or more buffer thresholds. Weighting at least the portion of the search criteria may be based at least in part on user input. The user input may include an identification of importance that affects the weighting. The user input may include user interactions that are evaluated to deduce one or more indications of importance that affect the weighting. Weighting at least a portion of the search criteria may be based at least in part on one or more default weights. Processing the search criteria may account for location. The search criteria may include and may be characterized by primary criteria and secondary criteria. The primary criteria and the secondary criteria may be weighted differently. The primary criteria may be weighted more than the secondary criteria. The secondary criteria may be categorized into at least a first category and a second category, where the first category is weighted more than the second category. The primary criteria may include at least one of price, location, and size. The secondary criteria may include at least one of a property feature attribute and a location attribute. The search criteria may be received from prompts provided to a user on the user interface. The scoring of one or more properties may include: assigning a full value of weighted points when there is a complete match between processed real estate data and a criterion of the processed search criteria; assigning a partial value of weighted points when there is a partial match between processed real estate data and the criterion of the processed search criteria; assigning no weighted points when there is no match between processed real estate data and the criterion of the processed search criteria; and summing values of weighted points to generate at least a portion of a score. The computer program product may include computer executable code that, when executing on the one or more computing devices, performs the step of displaying a score for each of the one or more properties. The computer program product may include computer executable code that, when executing on the one or more computing devices, performs the step of displaying information related to real estate data for one or more properties corresponding to at least a portion of the processed search criteria. The computer program product may include computer executable code that, when executing on the one or more computing devices, performs the step of providing a personalized view of the ranking of one or more properties. The personalized view may include identification of certain search criteria compared to one or more attributes of one or more properties. The personalized view may include a description related to the ranking. The computer program product may include computer executable code that, when executing on the one or more computing devices, performs the step of updating the real estate data. The real estate data may be automatically updated on a periodic basis. The computer program product may include computer executable code that, when executing on the one or more computing devices, performs the step of updating the property profile for one or more properties. The real estate data may be, at least in part, retrieved from a third-party database. The real estate data may be retrieved from at least two sources. The computer program product may include computer executable code that, when executing on the one or more computing devices, performs the step of prioritizing the real estate data based on a source of the at least two sources. The real estate data may include one or more of images and image attributes. The real estate data may include at least one of: neighborhood information, geospatial data, government data, a map, school data, and a satellite image. The real estate data may be extracted using a machine learning model. The model may be a machine learning model. Implementations of the described techniques may include hardware, a method or process, a system, and/or computer software on a computer-accessible medium.

In an aspect, a method disclosed herein may include: receiving real estate data for a plurality of properties from one or more third-party sources of data; processing the real estate data including at least one of normalizing the real estate data and tagging the real estate data to create a property profile for each listing included in the real estate data; receiving search criteria from a user, the search criteria including and characterized by primary criteria and secondary criteria; processing the search criteria including (i) weighting at least a portion of each of the primary criteria and the secondary criteria, and (ii) assigning a buffer threshold to at least one criterion of one or more of the primary criteria and the secondary criteria; analyzing, using a model, the processed real estate data by comparing the property profiles for one or more properties to the processed search criteria; scoring the one or more properties based on at least (i) a match between processed real estate data and the processed search criteria, the match at least in part accounting for the buffer threshold of the at least one criterion, and (ii) weighting of the processed search criteria; ranking the one or more properties based on the scoring; and displaying, on a user interface, at least a portion of the ranking of the one or more properties.

In an aspect, a system disclosed herein may include: a data network; a plurality of processors coupled to the data network; and a remote computing resource coupled to the data network, the remote computing resource including a processor and a memory. The memory may store code executable by the processor to perform the steps of: receiving real estate data for a plurality of properties from one or more third-party sources of data; processing the real estate data including at least one of normalizing the real estate data and tagging the real estate data to create a property profile for each listing included in the real estate data; receiving search criteria from a user; processing the search criteria including (i) weighting at least a portion of the search criteria, and (ii) assigning a buffer threshold to at least one criterion of the search criteria; analyzing, using a model, the processed real estate data by comparing the property profiles for one or more properties to the processed search criteria; scoring the one or more properties based on at least (i) a match between processed real estate data and the processed search criteria, the match at least in part accounting for the buffer threshold of the at least one criterion, and (ii) weighting of the processed search criteria; ranking the one or more properties based on the scoring; and displaying, on a user interface, at least a portion of the ranking of the one or more properties. The system may include a database for storing one or more of real estate data, property profiles, and search criteria.

In an aspect, a computer program product disclosed herein may include computer executable code embodied in a non-transitory computer readable medium that, when executing on one or more computing devices, performs the steps of: providing a platform for user interaction with one or more of the following-search criteria, property profiles, property listings, transaction documents, and property valuations; tracking user activity by a user of the platform; analyzing, using a machine learning model, the user activity to identify one or more triggers in activity; and, in response to identifying the one or more triggers in activity, transmitting a notification to one or more computing devices. Other embodiments of this aspect may include corresponding computer systems, apparatus, methods, devices, and computer programs recorded on one or more computer storage devices, each configured to perform one or more of the aforementioned steps.

Implementations may include one or more of the following features. The computer program product may include computer executable code that, when executing on the one or more computing devices, performs the steps of, using the machine learning model to: identify a pattern of user activity by the user; associate the pattern with the user; and identify a deviation in the pattern, where the deviation is a trigger of the one or more triggers. Analyzing the user activity may include comparing user interactions with expected interactions, and identifying a discrepancy related thereto. The machine learning model may, at least in part, include a user behavior analytics tool. The computer program product may include computer executable code that, when executing on the one or more computing devices, performs the step of segmenting the user into a group of users based on the user activity. At least one of the one or more triggers in activity may include: a search, interaction with a property listing, a change in a search criterion, interaction with a certain portion of the platform, a response to a prompt, completion of a transaction task, timing of a search relative to a predetermined milestone, and interaction with a property valuation. At least one of the one or more triggers in activity may include a discrepancy between user interactions with expected interactions. At least one of the one or more triggers in activity may be related to a threshold corresponding to one or more of: page views, click-through rates, conversion rates, and user flow. The notification may be transmitted to a computing device associated with a real estate professional. The notification may be transmitted to a computing device associated with the user. The notification may include a report.

In an aspect, a computer program product disclosed herein may include computer executable code embodied in a non-transitory computer readable medium that, when executing on one or more computing devices, performs the steps of: querying a user for search criteria on a user device via a computing platform; receiving the search criteria from the user; processing the search criteria to determine a relative importance of at least one criterion included in the search criteria; comparing the relative importance of the at least one criterion to features of one or more properties of interest for the user; calculating, based on the comparison, a demand for one or more features corresponding to the at least one criterion; and taking an action related to the calculated demand for the one or more features. Other embodiments of this aspect may include corresponding computer systems, apparatus, methods, devices, and computer programs recorded on one or more computer storage devices, each configured to perform one or more of the aforementioned steps.

Implementations may include one or more of the following features. The action may include adjusting a price of a property including the one or more features. The action may include adjusting a weighting of the one or more features used for searching a plurality of properties. The action may include calculating a likelihood of purchasing one or more properties including the one or more features for the user. The action may include determining whether the one or more features corresponding to the at least one criterion constituted a tradeoff made by the user. The action may include generating one or more of a notification and a report that includes information related to the tradeoff. The calculated demand may be based on a plurality of comparisons of relative importance to features of one or more properties from a plurality of users. The one or more properties of interest for the user may include a property the user viewed on the computing platform. The one or more properties of interest for the user may include a property the user purchased. The one or more properties of interest for the user may include a property the user made an offer for purchase.

These and other features, aspects, and advantages of the present teachings will become better understood with reference to the following description, examples, and appended claims.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein. In the drawings, like reference numerals generally identify corresponding elements.

FIG. 1 illustrates a system for providing a computer-implemented platform for real estate personnel, in accordance with a representative embodiment.

FIG. 2 is a flow chart of a method for relative importance-based searching, in accordance with a representative embodiment.

FIG. 3 shows an example user interface for designating search criteria, in accordance with a representative embodiment.

FIG. 4 shows an example user interface for designating search criteria, in accordance with a representative embodiment.

FIG. 5 shows an example user interface for assisting in creating and processing search criteria, in accordance with a representative embodiment.

FIG. 6 shows an example user interface for assisting in creating and processing search criteria, in accordance with a representative embodiment.

FIG. 7 shows an example user interface with a plurality of listings showing a score, in accordance with a representative embodiment.

FIG. 8 shows an example user interface with a plurality of listings showing certain attributes, in accordance with a representative embodiment.

FIG. 9 shows an example user interface with a listing showing a score and certain search criteria for a user, in accordance with a representative embodiment.

FIG. 10 shows an example user interface with a listing showing a score and certain search criteria for a user, in accordance with a representative embodiment.

FIG. 11 shows an example user interface with a listing showing a score and certain search criteria for a user, in accordance with a representative embodiment.

FIG. 12 shows an example user interface with a listing showing a score and information related to certain real estate data, in accordance with a representative embodiment.

FIG. 13 is a flow chart of a method for analyzing user activity on a platform for obtaining certain insights, in accordance with a representative embodiment.

FIG. 14 is a flow chart of a method for using a platform for obtaining certain insights, in accordance with a representative embodiment.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein. Rather, these illustrated embodiments are provided so that this disclosure will convey the scope to those skilled in the art.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “about,” “approximately,” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

In general, the devices, systems, computer-program products, and methods disclosed herein relate to a platform for real estate personnel, which can include real estate agents and affiliates thereof, real estate organizations, clients of real estate agents and organizations, individuals (e.g., those interested in buying, renting, and/or selling of property), property management personnel, and so forth. Although generally described with regard to residential real estate, it will be understood that the platforms and techniques of the present teachings may also or instead include commercial real estate and the like.

By way of example, a platform according to the present teachings may include improved searching and techniques for displaying search results, which may include relative importance-based searching having sophisticated filtering and/or weighting that can provide more pertinent, personalized, and/or comprehensive results than existing, mostly binary-filtering searching techniques. A platform according to the present teachings may also or instead include one or more workflow management tools, which, when also including the aforementioned searching tools, enables the present teachings to provide an all-in-one platform for real estate. Such a platform may, by way of example, include transaction management tools, document management tools, scheduling tools, communications tools, task management tools, compliance management tools, templating tools, signature processing tools, verification tools, and so forth. A platform according to the present teachings may also or instead include client retention tools, service prediction tools (and other prediction tools), service recommendation tools, property owner/management tools, communications tools, and the like. The platform according to the present teachings may also or instead be used to detect and analyze user interactions therewith (e.g., patterns of interactions or deviations from a pattern of interactions) for use as insights that can assist a user such as a real estate agent to understand their client's needs. The platform according to the present teachings may also or instead be used to gain insights into what features of properties are important (relatively) for a user or group of users, which can be grouped by demographics, location, price points, and otherwise. Any of the aforementioned features of such a platform, and/or the platform itself, may be implemented on a networked system, such as that described below.

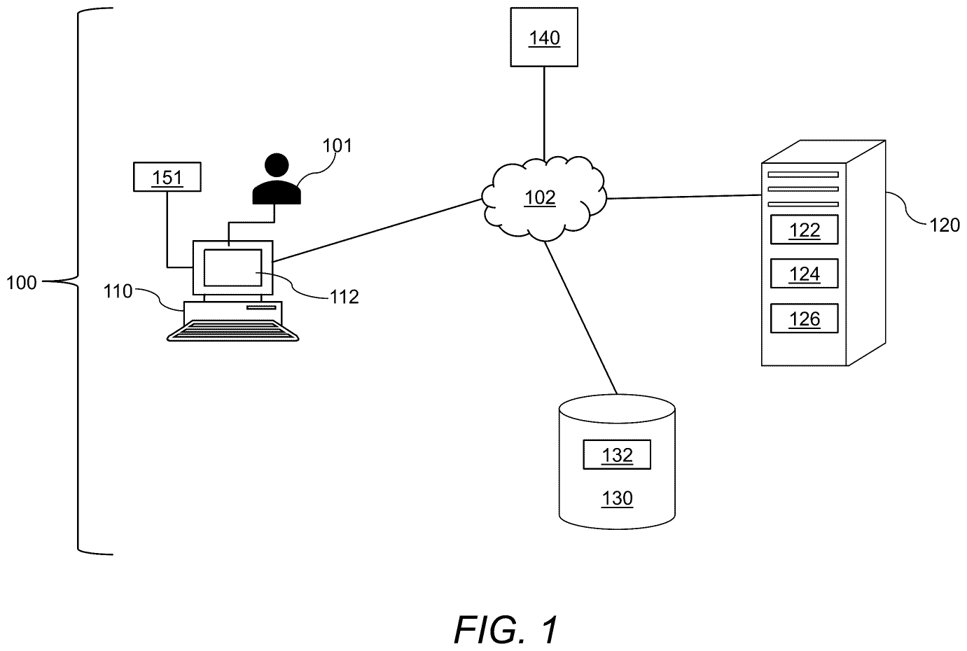

FIG. 1 illustrates a system for providing a computer-implemented platform for real estate personnel and similar, in accordance with a representative embodiment. In general, the system 100 may include a networked environment where a data network 102 interconnects a plurality of participating devices and/or users in a communicating relationship. The participating devices may, for example, include any number of user devices 110, remote computing resources 120, databases 130, and other resources 140.

The data network 102 may be any network(s) or internetwork(s) suitable for communicating data and information among participants in the system 100. This may include public networks such as the Internet, private networks, telecommunications networks such as the Public Switched Telephone Network or cellular networks using third generation (e.g., 3G or IMT-2000), fourth generation (e.g., LTE (E-UTRA) or WiMAX-Advanced (IEEE 802.16m)), fifth generation (e.g., 5G), and/or other technologies, as well as any of a variety of corporate area or local area networks and other switches, routers, hubs, gateways, and the like that might be used to carry data among participants in the system 100.

Each of the participants of the data network 102 may include a suitable network interface comprising, e.g., a network interface card, which term is used broadly herein to include any hardware (along with software, firmware, or the like to control operation of same) suitable for establishing and maintaining wired and/or wireless communications—e.g., a communications interface as described herein or otherwise known in the art. The network interface card may include without limitation a wired Ethernet network interface card (NIC), a wireless 802.11 networking card, a wireless 802.11 USB device, and/or other hardware for wired or wireless local area networking. The network interface may also or instead include cellular network hardware, wide-area wireless network hardware or any other hardware for centralized, ad hoc, peer-to-peer, or other radio communications that might be used to connect to a network and carry data. In another aspect, the network interface may include a serial or USB port to directly connect to a local computing device such as a desktop or laptop computer that, in turn, provides more general network connectivity to the data network 102.

A user 101 in the system 100 may include real estate personnel, such as one or more of the following: a real estate agent (and/or affiliates thereof), a client of a real estate agent or company, an individual associated with one or more properties (e.g., a property manager, an owner, a seller, a landlord, a buyer, and so on), an appraiser, other individuals with an interest in certain real estate, legal representatives, compliance providers, insurance companies and associated personnel, and the like. A user 101 may also or instead include an administrator for a platform according to the present teachings and/or a feature thereof. Other users 101 are also or instead possible.

The user devices 110 may include any devices within the system 100 operated by one or more users 101 for practicing the techniques as contemplated herein. Specifically, the user devices 110 may include any device for connecting to, and using, a platform according to the present teachings, and/or any device configured to provide, supplement, and/or support functionality of a platform according to the present teachings. The user devices 110 may also or instead include any device for managing, monitoring, or otherwise interacting with tools, platforms, and devices included in the systems and techniques contemplated herein. The user devices 110 may be coupled to the data network 102, e.g., for interaction with one or more other participants in the system 100.

By way of example, the user devices 110 may include one or more desktop computers, laptop computers, network computers, tablets, mobile devices, portable digital assistants, messaging devices, cellular phones, smart phones, portable media and/or entertainment devices, or any other computing devices that can participate in the system 100 as contemplated herein. As discussed above, the user devices 110 may include any form of mobile device, such as any wireless, battery-powered device, that might be used to interact with the networked system 100. It will also be appreciated that one of the user devices 110 may coordinate related functions (e.g., providing inputs, retrieving and/or processing data, and the like) as they are performed by another entity such as one of the remote computing resources 120 or other resources 140.

Each user device 110 may generally provide a user interface on a display 112 thereof, such as any of the user interfaces described herein. The user interface may be maintained by a locally executing application on one of the user devices 110 that receives data from, e.g., the remote computing resources 120 and/or other resources 140. In other embodiments, the user interface may be remotely served and presented on one of the user devices 110, such as where a remote computing resource 120 or other resource 140 includes a web server that provides information through one or more web pages or the like that can be displayed within a web browser or similar client executing on one of the user devices 110. The user interface may in general create a suitable visual presentation for user interaction on a display 112 of one of the user devices 110, and provide for receiving any suitable form of user input including, e.g., input from a keyboard, mouse, touchpad, touch screen, hand gesture, or other use input device(s).

The remote computing resources 120 may include, or otherwise be in communication with, a processor 122 and a memory 124, where the memory 124 stores code executable by the processor 122 to perform various techniques of the present teachings. More specifically, a remote computing resource 120 may be coupled to the data network 102 and accessible to the user device 110 through the data network 102, where the remote computing resource 120 includes a processor 122 and a memory 124, where the memory 124 stores code executable by the processor 122 to perform the steps of a method according to the present teachings.

The remote computing resources 120 may also or instead include data storage, a network interface, and/or other processing circuitry. In the following description, where the functions or configuration of a remote computing resource 120 are described, this is intended to include corresponding functions or configuration (e.g., by programming) of a processor 122 of the remote computing resource 120, and/or a processor 122 in communication with the remote computing resource 120. In general, the remote computing resources 120 (or processors 122 thereof or in communication therewith) may perform a variety of processing tasks related to providing a platform and/or its various features as discussed herein. For example, the remote computing resources 120 may manage information received from one or more of the user devices 110, and provide related supporting functions such as analyzing and processing data (e.g., normalizing data, prioritizing data, filtering data, and so forth), storing data, communicating with third-party resources, communicating with local resources, communicating with other resources 140, implementing one or more machine learning models 126 (and similar models and/or algorithms), transmitting and/or retrieving data from one or more databases 130, and the like. The remote computing resources 120 may also or instead include machine learning models 126 and/or backend algorithms, e.g., that react to actions performed by a user 101 at one or more of the user devices 110 or otherwise perform/enable functionality of a platform as described herein. The machine learning models 126 and/or backend algorithms may also or instead be located elsewhere in the system 100.

The remote computing resources 120 may also or instead include a web server or similar front end that facilitates web-based access by the user devices 110 to the capabilities of the remote computing resource 120 and/or other components of the system 100. A remote computing resource 120 may also or instead communicate with other resources 140 in order to obtain information for providing to a user 101 through a user interface on a display 112 of the user device 110. Where the user 101 specifies certain criteria for data processing, this information may be used by a remote computing resource 120 (and any associated machine leaning models and/or algorithms) to access other resources 140. Additional processing may be usefully performed in this context such as recommending certain data processing operations and techniques.

The remote computing resources 120 may also or instead include a prioritization engine (e.g., for prioritizing inputs received from a user 101), a ranking engine (e.g., for ranking real estate listings according to input received from a user 101 that is processed according to the present teachings), and so forth.

A remote computing resource 120 may also or instead be configured to manage access to certain content (e.g., for an enterprise associated with a user 101 of the user device 110). In one aspect, a remote computing resource 120 may manage access to a component of the system 100 by a user device 110 according to input from a user 101.

A remote computing resource 120 may also or instead maintain, or otherwise be in communication with, a database 130 of content, along with an interface for users 101 at the user devices 110 to utilize the content of such a database 130. This may include one or more local, remote, in-house, and/or third-party databases 130. Content included in such a database may include real-estate data 132 such as one or more of the following: property listing data such as Multiple Listing Service (MLS) data or similar, neighborhood information, geospatial data, images and/or videos (e.g., real estate listing images and/or tours, street views, and so on), government data, maps, satellite images or other similar images, and the like. The database 130 may store raw data (e.g., MLS data), processed data (e.g., tagged MLS data), user inputted data (e.g., in a raw and/or normalized format, such as search criteria provided by a user 101), filtered data, current or previous search results, rules for data processing and/or analysis, and so on. The database 130 may also or instead include data such as documents (e.g., documents related to a real estate listing and/or transaction), form templates, calendars and/or other schedules, and the like.

The other resources 140 may include any resources that may be usefully employed in the devices, systems, computer program products, and methods as described herein. For example, the other resources 140 may include without limitation other data networks, human actors (e.g., real estate personnel, programmers, researchers, annotators, editors, analysts, and so forth), sensors (e.g., audio or visual sensors), data mining tools, computational tools, data monitoring tools, and so forth. The other resources 140 may also or instead include any other software or hardware resources that may be usefully employed in the networked applications as contemplated herein. For example, the other resources 140 may include payment processing servers or platforms used to authorize payment for access, content or feature purchases, or otherwise. In another aspect, the other resources 140 may include certificate servers or other security resources for third-party verification of identity, encryption or decryption of data, and so forth. In another aspect, the other resources 140 may include a desktop computer or the like co-located (e.g., on the same local area network with, or directly coupled to through a serial or USB cable) with one of the user devices 110 or remote computing resources 120. In this case, the other resource 140 may provide supplemental functions for the user device 110 and/or remote computing resource 120. Other resources 140 may also or instead include supplemental resources such as scanners, cameras, printers, input devices, and so forth.

The other resources 140 may also or instead include one or more web servers that provide web-based access to and from any of the other participants in the system 100. While depicted as a separate network entity, it will be readily appreciated that the other resources 140 (e.g., a web server) may also or instead be logically and/or physically associated with one of the other devices described herein, and may, for example, include or provide a user interface for web access to a remote computing resource 120 or a database 130 in a manner that permits user interaction through the data network 102, e.g., from a user device 110.

It will be understood that the participants in the system 100 may include any hardware or software to perform various functions as described herein. For example, one or more of the user device 110 and the other resources 140 may include a memory 124 and a processor 122.

The various components of the networked system 100 described above may be arranged and configured to support the techniques described herein in a variety of ways. For example, in one aspect, a user device 110 connects through the data network 102 to a server (e.g., that is part of one or more of the remote computing resource 120 or other resources 140) that performs a variety of processing tasks related to providing a platform as described herein and/or providing functionality of such a platform. For example, the remote computing resource 120 may include a server that hosts a website that runs a platform as described herein. More specifically, a user 101 associated with the user device 110 and having appropriate permissions for using the system 100 may use the user device 110 to, e.g., input search criteria, search listings or otherwise review search results and related data, access real estate transaction information, use communications tools, review client retention tools or similar, access documents and/or templates, and so forth.

### Platform Overview

As discussed above, the present teachings may include a platform for real estate personnel, such as real estate agents and/or their clients. Examples of such a platform will now be described.

In real estate, there are typically two primary verticals for real estate technology—marketing/business development (“marketing”) and operations. Given the industry's heavy-focus on lead generation, marketing platforms (customer relationship management (CRM) platforms, digital advertising systems, etc.) tend to be the areas that get the most focus and attention. These platforms are typically focused on lead generation and lead conversion. If operations are defined as the activities that occur after a lead becomes a client, there are many existing “point solutions” for operations, but not many platforms offering a plurality of uses and functionality all in one place. For example, many real estate agents use one platform for transaction management (and often another one for e-signatures), the MLS platform and/or a third-party application for searching, a separate system for showings, shared drives for document management, and manual e-mail driven processes for client communications, offers, and the like. This results in an inefficient and, often, expensive process for agents, while diminishing the client experience due to the lack of accessibility, cohesion, and transparency. In addition, post-transaction client retention is a significant gap across most available platforms.

The present teachings may solve some of the aforementioned issues for both agents and clients by creating a comprehensive platform having a workflow management system and/or other advantageous functionality. In some aspects, the platform of the present teachings can be used when a user, individual, or entity decides to work with an agent, where the platform can be utilized for one or more of: searching, transaction management, and post-transaction client retention. To this end, there are various modules that can be provided in a platform according to the present teachings, some of which are described below by way of example.

Collaborative Search: this module may allow agents to invite their buyers into the platform and search within the platform. The platform may integrate with an MLS platform (or other platform) and enrich MLS data (or other property data) with third-party data sources, image attributes, and the like. This can limit a need for agents and clients to look beyond the platform to view property-related data. The module may offer relative importance-based searching, personalized property views, property comparisons, tour scheduling, and/or other related features.

Transaction Management: this module may form, or be part of, a transaction management module. Individual transactions within the platform may be designed to be collaborative—e.g., where agents can invite clients and third parties (e.g., lenders, title companies, lawyers, insurers, appraisers, etc.) into the platform to ensure one source of truth and increase visibility for all parties. This module may allow for timeline management, task management, document management, integrated forms (e.g., having e-signature capabilities), and/or built-in compliance logs. This module may also or instead include offers and showings management for listings, and similar. This module may also or instead include powerful templating and automations to minimize redundant work for agents and their clients, and to mitigate risks of non-compliance.

Vendor Management: this module may be provided as part of a client retention suite. For example, using this module, agents can showcase recommended service providers and vendors, where clients can access these recommendations during and/or after a transaction. This may be particularly advantageous as clients can benefit from vetted recommendations, as well as the ability to shop for services in a simplified, organized manner; and agents can benefit from staying top of mind with clients, while getting visibility into vendor performance.

The vendor management module, or another module, may also provide “apples-to-apples” cost comparison templates and/or assist in assessing pricing norms, cost of fixes identified in home inspection reports, cost of proposed updates/renovation, and the like. This may further include functionality for home service providers to manage their businesses by providing capabilities for: quoting, scheduling, resource management, inventory management, client communication, etc. The platform may also or instead allow users to request and manage quotes through the vendor management module.

Client Engagement: as part of the platform's client retention and/or engagement functionality, the platform may use property information, transaction information, vendor management recommendations (as described above), and/or miscellaneous data sources to power personalized dashboards and drip campaigns (e.g., keep in touches (KITs) and similar) for clients that can be branded to agents. These resources may be accessible to clients post-transaction, helping keep the agent top of mind through personalized and actionable communications. Examples can include notifications on nearby property activity, reminders to appeal property tax assessments, and the like.

Further, a platform according to the present teachings may include homeowner dashboards—e.g., personalized, dynamic dashboards for clients that can be accessed anytime, and which may include any of the information provided herein.

Other: the present teachings may also or instead include in-app messaging, configurable notifications, team management, enterprise management, and/or reporting. For example, regarding client retention, the platform may have the ability to create and transmit personalized communications (e.g., communications tailored to a specific client and/or property) because of the data visibility enabled through it being a relatively all-in-one platform. This can include personalized drip campaigns and/or personalized retention campaigns.

### Relative Importance-Based Searching

The present teachings (e.g., a platform as described herein) may include relative importance-based searching, examples of which are described below.

The majority of traditional property search applications use an entirely filters-driven approach. This, however, is extremely binary and is thus not necessarily related to how consumers think. Specifically, consumers typically have a budget, target locations and a “wish list.” This wish list is generally composed of property, lot, and/or location-based attributes, each with varying degrees of importance to the consumer. Most often, the primary categories of a wish list are “needs” (i.e., must-haves) and “wants” (i.e., nice-to-haves). In most cases, consumers rarely find a property that has everything on their wish list, that is in their budget, and that is situated in their preferred location, while also being available for sale at the time that they are looking. Accordingly, consumers will usually decide on whether or not to purchase a property based on how much of their particular wish list is met, exactly what combination of wish-list factors that property has, and how that stacks up relative to price and location. This inherently conflicts with the very binary nature of most existing filters.

For example: a prospective buyer in Las Vegas, Nevada may have a property with a pool being relatively high on their wish list and designate that as a need/must-have. In a filter driven search, there are typically two options. The first is to toggle-on the filter for pools. In that scenario, the buyer will only see properties with pools. However, it is very likely that a property that has room for a pool and room in the budget to put in a pool, as well as the majority of other wish-list items the buyer is looking for, would be a viable contender if available. If the buyer wants to look for opportunities such as this one, they will likely need to toggle-off the filter for pools; however, they would then be stuck sifting through each property individually to determine which have a pool, which have room for a pool (and a price point to accommodate installation thereof), and which have neither, as well as how that all relates to their other criteria (not to mention keeping track of all of this information). Clearly, this type of searching filter has its flaws.

In another example, a prospective buyer in Dallas, Texas may feel it is important for a property to be within a 25-minute drive of their office. For most buyers in this scenario, 26 minutes would not be a deal breaker; however, a traditional filter would not show a property that is only 26 minutes away if the filter is set to a maximum of 25 minutes. Thus, the onus falls on the consumer to create their filters in such a way that they account for buffers and, even if they do so, they will likely need to manually sort through the properties to see which is within their ideal commute versus their buffer.

In addition to the conflicting nature between how consumers think and existing filters, there is also a convenience issue. In traditional search applications, even with precise filters, there is typically a manual process where the consumer and/or agent must scroll through all of the details of that property to isolate the features that are most important to them, and manually track these features. This often results in disparate emails, notes, spreadsheets, and so on. Also, it is often the case that consumers go into a search with certain requirements and expectations, but may adjust those when seeing properties in person, understanding available inventory, and so on. When relying solely on filters, this natural evolution can sometimes be hindered, as the client would not see anything outside of the set filter parameters.

The present teachings may advantageously solve one or more of the aforementioned issues with traditional, binary real estate searching. In particular, the present teachings may advantageously include relative importance-based searching. To this end, a platform according to the present teachings may include identification and tracking of property attributes through a user interface that can be used to personalize the view of each property at the consumer level, e.g., so a consumer is seeing the factor/attributes most important to them. Similarly, for agents, the platform can provide a reconciliation against each client's wish list and a streamlined view of that reconciliation across all properties. Moreover, dynamic searching according to the present teachings may address intense market conditions that often require consumers to make rapid decisions—i.e., having more analysis up-front can support these urgent decisions.

An example technique of relative importance-based searching is set forth below.

A technique for providing relative importance-based searching may include analyzing and retrieving real estate data, which can be used to create a comprehensive property profile. This may include retrieving, analyzing, processing, and combining one or more of property listing data such as Multiple Listing Service (MLS) data or similar, third-party database data (e.g., neighborhood-based information, geospatial data, and the like), and image attributes, where any one or more of these can be extracted through the use of one or more machine learning models or other computer-implemented tools. It should be noted that the data used to create a property profile may be highly variable and subject to change over time, and thus the property profile may be continuously or periodically updated, and this process may be automated.

The property profile may include processed data—e.g., where the data is normalized, tagged, or otherwise processed to be used on a platform according to the present teachings. In an example, the order of data sources may be prioritized when creating a property profile—e.g., if data is received as a data element from the MLS and from a third-party, the MLS data may be used as the source of truth (e.g., if there is conflicting information or otherwise a discrepancy or error).

Relative importance-based searching may include receiving search criteria. That is, agents and/or their clients can designate “primary criteria.” Such primary criteria may include price, location, size (e.g., square footage, beds, baths, lot size, etc.), and the like, where such criteria can be revised at any time.

Match scores may be provided for properties in the primary criteria, as well as for some properties outside of this criteria. For example, if a property is in the primary criteria, the platform may not filter out the property based on wish-list attributes, but instead may rank the property accordingly using the scoring described herein. For properties outside of the primary criteria (e.g., slightly outside of the criteria), although filtering may be (at least partially) based on primary criteria, the present teachings may provide a “flexible view,” which can calculate match scores for properties within and just outside of certain primary criteria parameters. This can be accomplished by introducing buffers and searching within those buffers. By way of example: if a user says they want to be in Lincoln Park-Chicago, spend between $450k-550k, and get a 3+ bed, 2+ bath property, the present teachings may also provide properties that are just outside of neighborhood boundaries; just over/under the budget; and just over/under the size parameters. Certain buffer thresholds can be automatically set by the platform and/or provided by a user. This can be used to ensure that properties that could be viable contenders are not omitted. In this manner, the “flexible view” can be considered an “add-on” where the platform captures properties just outside of primary criteria so users are seeing anything that may be a contender.

Relative importance-based searching may include receiving additional search criteria. That is, agents and/or their clients can designate “wish-list criteria,” or otherwise designate search criteria. Such wish-list criteria and/or other search criteria may include any number of attributes related to the property (e.g., interior and exterior features) and/or neighborhood/lifestyle options. In this manner, users can designate which items they want to include in their wish list and whether that item is a ‘need’ or a ‘want,’ and/or otherwise designate relative importance of certain search criteria. An interactive wizard (e.g., an interactive user interface that helps a software user complete a task one step at a time) may guide a user through this process, or any of the steps described herein.

Relative importance-based searching may include, once the primary criteria and wish-list criteria have been defined, filtering properties, which may be done initially through the use of the primary criteria (with or without thresholds to provide buffers). Then, instead of further filtering out and removing properties based on one or more criteria from the wish list, the present teachings may rank properties based on one or more wish-list elements. Examples of the ranking are described below.

The ranking may be accomplished using a match score. This score may be calculated by: attributing a weighted value to needs; attributing a weighted value to wants; and attributing a total possible score based on the number of needs/wants that a user has designated. Thereafter, a database of real estate data may be analyzed, which can include scanning each property within primary criteria to identify which needs/wants are present.

Identifying how the needs/wants should be measured against the property profile can include scanning data sources based on a ranking (for example, if MLS is the primary source of truth, the data from MLS will be used before seeking another source). And, in some instances, the determination of a primary source of truth and/or a ranking of sources of truth may vary from attribute to attribute—e.g., MLS data may not be a primary source of truth if there is a more reliable option. Thus, the present teachings may include logic that accounts for an attribute and an order of reliability for sources of data related specifically to that attribute, where based on this logic, the most reliable source of truth of data available is selected for use in the present teachings. For neighborhood and/or other location-based-wish-list items, there may be variability in how that attribute should be assessed. For example, if the user says “Proximity to Restaurants” is important, that user's definition of proximity may vary if they live in Downtown Chicago versus rural Iowa. Accordingly, the system may assess a threshold radius and volume measurements to use based on the type of geographic location or other pertinent information. This may be done automatically and/or with input from a user.

Relative importance-based searching may include assessing matches based on any or all of the above. Matches may be categorized by whether: if a need/want is present and a full match; if a need/want is present and a partial match; if a need/want is absent; or if a need/want is undefined. If a full match, that attribute may receive the full value of the weighted points. If a partial match, it may receive a partial value of the weighted points. If absent or undefined, it may not receive any value of the weighted points. Also or instead, if undefined and/or absent, the present teachings may neutralize an impact on the score—e.g., there is a difference between when a house truly does not include a feature versus a situation where a listing does not clarify whether a feature is included or not, and the scoring may factor this into a calculation. However, techniques may include drawing a visual distinction between whether something is not receiving points because the property truly does not meet the threshold or because the system was unable to assess that attribute.

The match score, once calculated, can be used to organize the display of properties within searches and feeds, drive notifications or other communications, and the like. In some aspects, agents may have the ability to, at a glance, see the score and subsequent breakdown of all properties and clients for which those properties and their primary criteria align. In essence, this can create a property analysis for one or more clients. That is, through the various techniques described herein, the present teachings is able to discern the relative importance to a user of certain features related to properties, and in this manner, the present teachings can provide an overview or report of a property that shows and describes how that property matches with the user's features of interest. In some aspects, clients may have the ability to see a personalized view of each property, e.g., where this view emphasizes or otherwise describes features considered to be relatively important for the user. Moreover, property analyses may be provided for properties with certain buffers taken into account as described herein, e.g., so that relatively important features are emphasized, while less important features to a user that may not match a property do not preclude the property from consideration by the user. Also or instead, such buffers/property analysis can help a user take into account considerations they may not have otherwise—e.g., if a price is above a stated price preference by a small amount, other features of a property may offset this higher price. Such a personalized view may include one or more of: a breakdown of their wish list as it relates to that specific property; and/or insights for each wish-list item, such as providing a high-level description of the data that was used to arrive at the match value for each attribute. In some aspects, both agents and clients can compare properties side-by-side, e.g., based on regular attribute lists and/or wish list views.

Several advantages of relative importance-based searching are described below. This search methodology can help ensure that properties are not missed by being over-filtered. This search methodology can help reduce manual tracking, searching, and sorting through individual property data—for example, if a particular school district is important to a user, rather than the user having to scroll to that section each time and manually keep track of which property is in that district, the system will show that at the top of the list. This search methodology can provide consumers with personalization in the search experience and can allow agents to provide such personalization at scale. This search methodology can provide quantitative data and points of measurements against some of the subjective elements of the search process. This search methodology can help increase agent bandwidth and customer satisfaction. This search methodology can also provide property analyses in real-time/at scale so users have beneficial information to make decisions on properties, especially in fast-moving markets where speed may be necessary.

With relative importance-based searching, the granularity at which the attributes of a property are measured, and the specific demand of those attributes, can help do one or more of the following: increase accuracy in Comparative Market Analyses and appraisals (thereby increasing accuracy in pricing); test demand for potential property sales; allow for more precise reverse prospecting and deal-matching; more precisely measure the value and impact of certain upgrades, features, renovations, and the like; and increase the depth of overall industry reporting as it relates to consumer demand.

A further example of the weighting will now be described.

Weighting may include assigning a weighted value for needs—e.g., 7 points per need. Weighting may include assigning a weighted value for wants—3 points per want. Based on the number of items on the user's wish list, there is a total value that can be achieved. A computing tool, such as a machine learning model, may review and analyze a plurality of real estate data (e.g., property data and metadata from MLS listings and the like, from one or more sources of such data) to identify how many needs are present, how many wants are present, and if there are partial matches.

An example of a partial match can include: the user has designated a 15-minute driving commute as a need; if the commute time is 15 min or less, it is a full match; if the commute time is within a defined buffer (e.g., 5 minutes, 10 minutes, 15 minutes, and so forth), it is a partial match. So, a 20-minute commute would be a partial match if the buffer includes at least 5 minutes. Partial matches may be assigned 50% of the total point value depending on if it is a need or want—where other assigned values for partial matches are also or instead possible, and may be scaled based on importance or other factors.

The total for full and partial matches may be combined (and, optionally, weighted before or after combining) to derive a score for that property, which can be divided by the total possible score to establish the match percentage.

It will be understood that the examples herein use point values and specific weights for understanding the present teachings, and that the actual point values can vary and be customizable for particular users of a platform.

It will be further understood that, as described herein, aspects of the present teachings may include analyzing a plurality of data (e.g., real estate data from one or more sources such as MLS listings, third-party listings on websites and the like, social media posts, periodic publication content, advertisements, and the like) to identify matches, partial matches, and non-matches for certain data attributes. A number of computing tools may be used for this purpose, including one or more of: data visualization tools, statistical analysis tools, machine learning tools (e.g., tools utilizing algorithms and models to automatically identify patterns and extract insights from data, where such tasks may include classification, regression, clustering, and anomaly detection), Natural Language Processing (NLP) tools (e.g., tools used to analyze and extract information from text data, such as by identifying keywords and relationships within textual information), data mining tools (e.g., tools configured to assist in discovering patterns, associations, and relationships within large datasets, where such tools may employ techniques such as clustering, classification, and association rule mining), and the like.

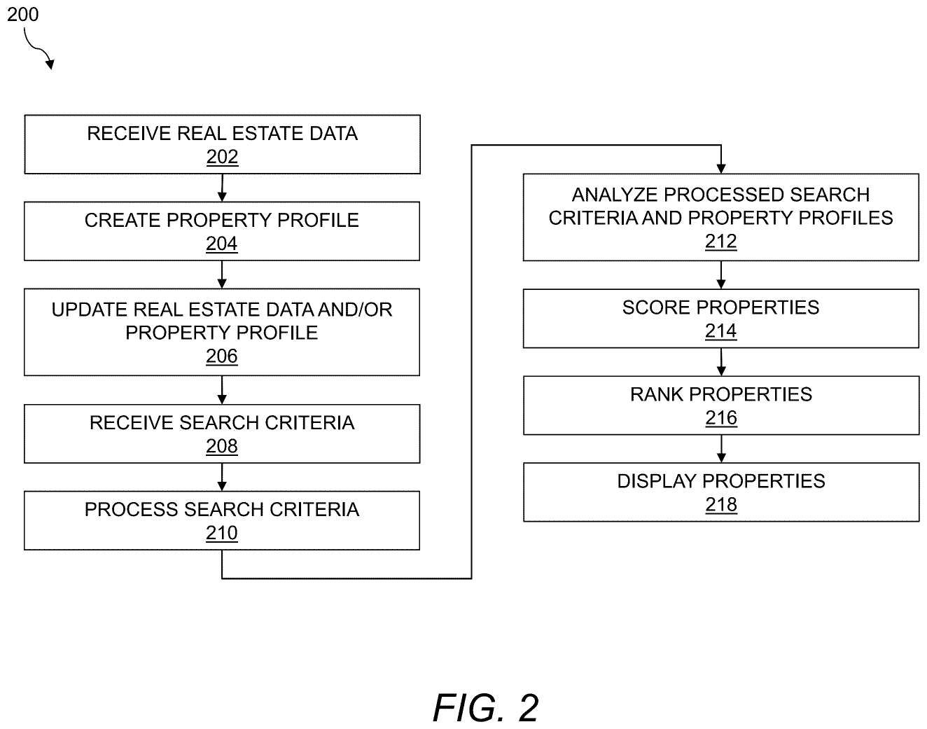

FIG. 2 is a flow chart of a method for relative importance-based searching, in accordance with a representative embodiment. The method 200 may be performed using a system such as any described herein, e.g., the system 100 of FIG. 1. And, in some aspects, the method 200 may be performed by a computer program product comprising computer executable code embodied in a non-transitory computer readable medium that, when executing on one or more computing devices, performs one or more of the steps of the method 200. The method 200 may generally recite a technique for providing relative importance-based searching that improves upon more restrictive binary-based searching of existing techniques.

As shown in step 202, the method 200 may include receiving real estate data for a plurality of properties. This may include properties listed for sale—i.e., real estate related listings or similar—which may be referred to herein as simply “listings.” The real estate data may also or instead be associated with one or more properties that are not currently listed for sale. The real estate data may include any as described herein. For example, the real estate data may include basic information such as an address, square footage, number of rooms, types of rooms/spaces, property type (e.g., residential, commercial, industrial, etc.), lot size, and the like. The real estate data may also or instead include one or more other attributes of properties such as property feature attributes and/or location attributes.

Examples of property feature attributes include: interior or exterior sizes of certain areas (e.g., bedrooms, bathrooms, kitchen, living room, dining room, etc.); kitchen information (e.g., number, appliance information, counter space, etc.); parking space, garage, carport, and similar parking/storage information; heating, ventilation, and air conditioning (HVAC) information; design and layout information, e.g., whether a property has an open floor plan, natural light, storage, outdoor living space, and the like; energy efficiency information; smart home feature information; and so forth. Examples of property feature attributes may also or instead include whether a property includes, permits, or can accommodate one or more of the following: home office; gym or exercise room; swimming pool; garden; yard space (e.g., front yard and/or backyard); walk-in closet; fixture information (e.g., bath fixtures, lighting fixtures, etc.); high ceilings; architectural details; home theater and/or entertainment room; guest house, in-law suite, and/or bonus spaces; unique elements; and so forth. Examples of property feature attributes may also or instead include whether a property has the potential for expansion and/or other construction projects.

Examples of location attributes include: school district information (e.g., objective and/or subjective information regarding nearby schools and the like); neighborhood safety statistics; proximity to points of interest and/or nearby amenities (e.g., work, other home, gym, restaurants, schools, parks, shops, hospital, entertainment centers, and the like); access to public transportation; walkability; and so forth.

The real estate data may also or instead include one or more of the following: transaction data such as information regarding property transactions including sale prices, dates of previous sales, buyer and seller information, terms of sale, and the like; ownership data such as information regarding an owner of a property, a history of ownership, stakeholder details, contact information, and the like; price data and price trend data such as historical data about how property prices in a particular area have changed over time; market analysis data such as information regarding supply and demand, vacancy rates, rental rates, absorption rates, and the like; zoning information including permitted uses, restrictions, future zoning changes, and the like; geospatial data, e.g., location-based data that can include geographic coordinates, maps, aerial imagery, other imagery, and data on nearby features like schools, parks, and transportation infrastructure, and the like; demographic and/or socioeconomic data such as information regarding the population in a particular area, including, e.g., age distribution, income levels, education, employment statistics, pet ownership, and the like; construction and development data such as information regarding ongoing or planned construction projects, building permits, developer information, expected completion dates, and the like; environmental and risk data such as information regarding flood zones, earthquake fault lines, soil stability, environmental contamination, and other risks that might affect property values and/or usability; legal and regulatory data such as information regarding legal disputes, liens, foreclosures, building code violations, compliance with regulations (e.g., local, state, and/or federal regulations), and the like; insurance related information; financial data such as mortgage and lien data, property tax information, investment performance data, and the like; utility data such as information regarding utility usage and costs, including data on water, electricity, gas, and other services; technology and smart data, e.g., data from smart buildings and IoT devices that monitor aspects such as energy consumption, building access, security systems, and the like; building safety and/or property safety information and/or features; and so forth.

Thus, in general, the real estate data may include at least one of neighborhood information, geospatial data, government data, a map, school data, images (e.g., street views, a satellite image, interior images, exterior images, and so forth), and the like. Also or instead, the real estate data includes one or more of images and image attributes (e.g., time stamps, labeling, metadata, etc.).

The real estate data may be received from, and/or otherwise retrieved from, one or more third-party sources of data. For example, the real estate data may be at least in part retrieved from a third-party database or the like. In an aspect, the real estate data is retrieved from at least two sources. In such aspects, the method 200 may include prioritizing the real estate data based on its source—for example, conflicting information may be filtered to include only information from a more trusted source of information. Sources of real estate data may include one or more of the following: multiple listing services (MLS) databases; public records and/or government sources; real estate websites and/or online portals; commercial data providers; market research firms; real estate brokerages and/or agents; investor sources; publications such as newspapers, magazines, and the like; financial institutions; industry reports and/or journals; geographic information systems (GIS) and/or mapping services; social media and/or networking sites; and so forth.

It will be understood that the real estate data may be “received,” at least in part, by retrieving such information, which can be automated for efficiency. For example, the real estate data may be extracted using a machine learning model or the like. Also or instead, the real estate data can be extracted by one or more of a web scraper, an application programming interface (API), a data aggregator, and the like.

As shown in step 204, the method 200 may include creating a property profile. Specifically, the method 200 may include processing the real estate data including at least one of normalizing the real estate data and tagging the real estate data to create a property profile for each listing included in the real estate data. Normalizing the real estate data may include formatting and/or otherwise standardizing the data for use on a platform according to the present teachings. Tagging the real estate data may include application of one or more data labels and/or tags for use by a computer model.

As shown in step 206, the method 200 may include updating the real estate data. For example, the real estate data may be automatically updated on a periodic basis and/or updated based on a detected change in the data. Similarly, the method 200 may include updating the property profile for one or more properties, e.g., based on updated real estate data.

As shown in step 208, the method 200 may include receiving search criteria from a user. The user may include someone having an interest in a property, such as a real estate agent, a client of a real estate agent, an investor, a service provider, a financial product provider, and so forth. In certain aspects, the search criteria includes and is characterized by at least primary criteria and secondary criteria. The primary criteria may include the most salient criteria for the user, which typically will include price, location, and/or size. And the secondary criteria may include at least one of a property feature attribute and a location attribute, such as any of those described herein.

In some aspects, the secondary criteria may be categorized into at least a first category and a second category—e.g., where the first category represents attributes typically associated with or otherwise identified (e.g., by the user or another) as “needs,” and where the second category represents attributes typically associated with or otherwise identified (e.g., by the user or another) as “wants.” The wants and needs may be any as described herein, including any of the elements of the real estate data mentioned above. Categorization of the secondary criteria may be done by default and/or customized based on information provided by the user. For example, the user may, when providing the search criteria, identify one or more attributes as cither wants or needs, or similar. Also or instead, a platform according to the present teachings may use a computer model to deduce wants and needs for a user based on how the user provided the search criteria (e.g., how the user responded to one or more prompts), and categorize the criteria accordingly. In this manner, the search criteria may be received from prompts provided to a user on a user interface. The prompts may include any as shown and/or described herein.

However, it shall be understood that the present teachings may perform relative importance-based searching without including or using (e.g., characterizing) primary or secondary criteria (or sub-categories thereof) as so defined in such explicit categories, and may instead evaluate at least some portion of search criteria based on an expressed, calculated, inferred, and/or deduced relative importance. That is, a focus of the present teachings may include receiving search criteria and establishing the relative importance of one or more pieces of criteria included therein. Thus, it shall be understood that the characterization, labeling, or similar of search criteria into categories may be omitted without departing from the scope of this disclosure, and more specifically, without departing from the scope of the relative importance-based searching as described herein.

As shown in step 210, the method 200 may include processing the search criteria. Processing the search criteria may include at least (i) weighting at least a portion of the search criteria (e.g., at least a portion of each of the primary criteria and the secondary criteria), and/or (ii) assigning a buffer threshold to at least one criterion of the search criteria (e.g., at least one criterion of one or more of the primary criteria and the secondary criteria).

In an aspect, weighting at least a portion of each of the search criteria is based at least in part on user input. For example, user input may include an identification of importance that affects the weighting, e.g., an express identification that a criterion is important to the user and/or identification of relative importance to the user. Also or instead, user input may include one or more user interactions that are evaluated to deduce one or more indications of importance that affect the weighting. Weighting at least a portion of the search criteria may also or instead be based at least in part on one or more default weights.

In aspects that include primary/secondary criteria, the primary criteria and the secondary criteria may be weighted differently. For example, the primary criteria may be weighted more than the secondary criteria. In some aspects, and as described above, the secondary criteria is categorized into at least a first category and a second category. In this manner, the first category may be weighted more than the second category—e.g., when the first category corresponds to “needs” and the second category corresponds to “wants,” the first category may be weighted more than the second category.

Assigning a buffer threshold to at least one criterion may be done to capture one or more properties that would otherwise be ignored. By way of example, a buffer may be assigned to one or more of the following: price, one or more location attributes, size, scores (e.g., school ratings, walkability scores, energy related scores, and so forth), and the like. The buffer may be assigned dependent upon and/or contingent upon one or more other factors. By way of example, if a user specifics inclusion of a pool as a need or must-have, a buffer may be assigned that allows for the identification/display of a property lacking a pool but otherwise having (i) space for a pool and (ii) a price point that would allow for a pool given the user's budget; however, if zoning of the property does not permit a pool, the buffer may not be assigned, even when the other characteristics are present. The buffer may be based on a percentage and/or another value. The buffer may be a default value and/or it can be at least partially customized for one or more of a particular user, location, and the like.

Processing the search criteria may account for certain information such as location or the like. By way of example, and as explained above, if a user indicates that ‘proximity to restaurants’ is important, that user's definition of proximity may vary if they live in an urban locale versus a rural locale. This can affect weighting of certain criteria and/or a buffer provided to a criterion.

As shown in step 212, the method 200 may include analyzing, using a model (e.g., a machine learning model), the processed real estate data. This may include comparing the property profiles for one or more properties to the processed search criteria. And, as shown in step 214, the method 200 may include scoring one or more properties based on at least (i) a match between processed real estate data and the processed search criteria—where the match at least in part accounts for the buffer threshold of at least one criterion—and (ii) weighting of the processed search criteria. In an aspect, all properties within buffer thresholds are scored.

By way of example, scoring of one or more properties may include: assigning a full value of weighted points when there is a complete match between processed real estate data and a criterion of the processed search criteria; assigning a partial value of weighted points when there is a partial match between processed real estate data and the criterion of the processed search criteria; assigning no weighted points when there is no match between processed real estate data and the criterion of the processed search criteria; and summing values of weighted points to generate at least a portion of a score. Other types of scoring are also or instead possible.

As shown in step 216, the method 200 may include ranking one or more properties based on the scoring. And, as shown in step 218, the method 200 may include displaying—e.g., on a user interface—at least a portion of the ranking of one or more properties. In certain aspects, the method 200 may include displaying a score for one or more properties. Also or instead, the method 200 may include displaying information related to real estate data for one or more properties, e.g., such as attributes corresponding to at least a portion of the processed search criteria. In certain implementations, the method 200 may include displaying at least one listing having a parameter falling outside of the search criteria but within one or more buffer thresholds.

The method 200 may include providing a personalized view of the ranking of one or more properties. For example, such a personalized view may include identification of certain search criteria (e.g., certain primary criteria and/or certain secondary criteria) compared to one or more attributes of one or more properties. Also or instead, the personalized view may include a description related to the ranking.

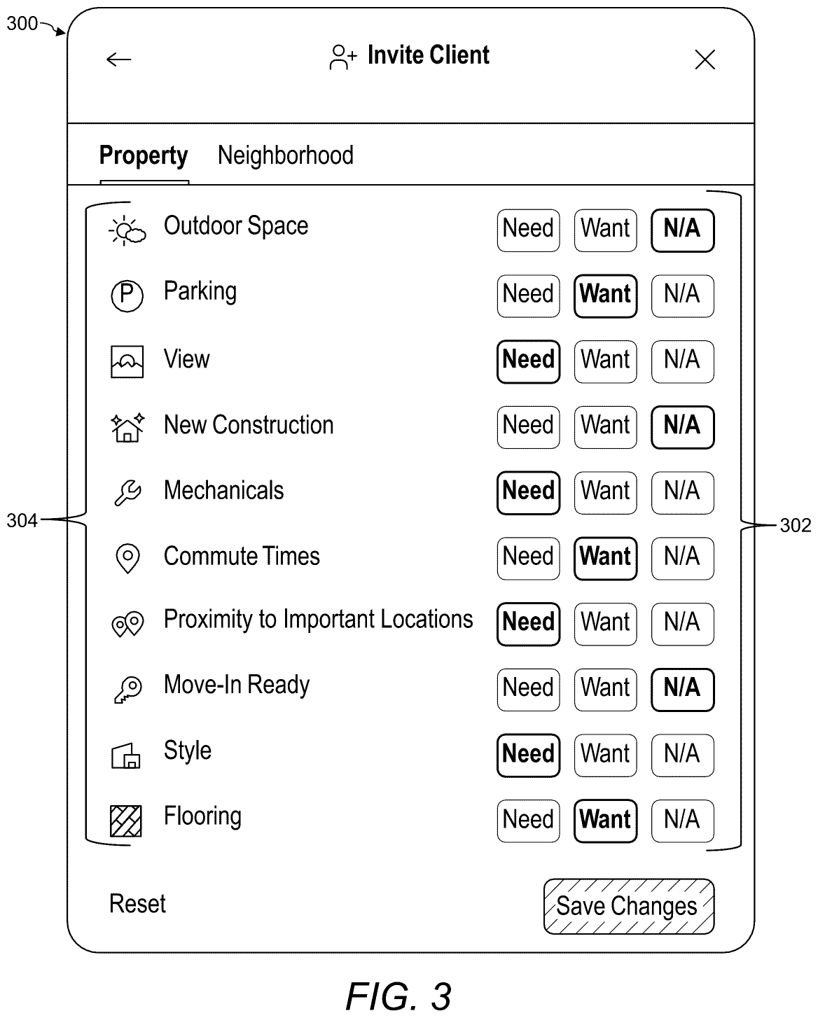

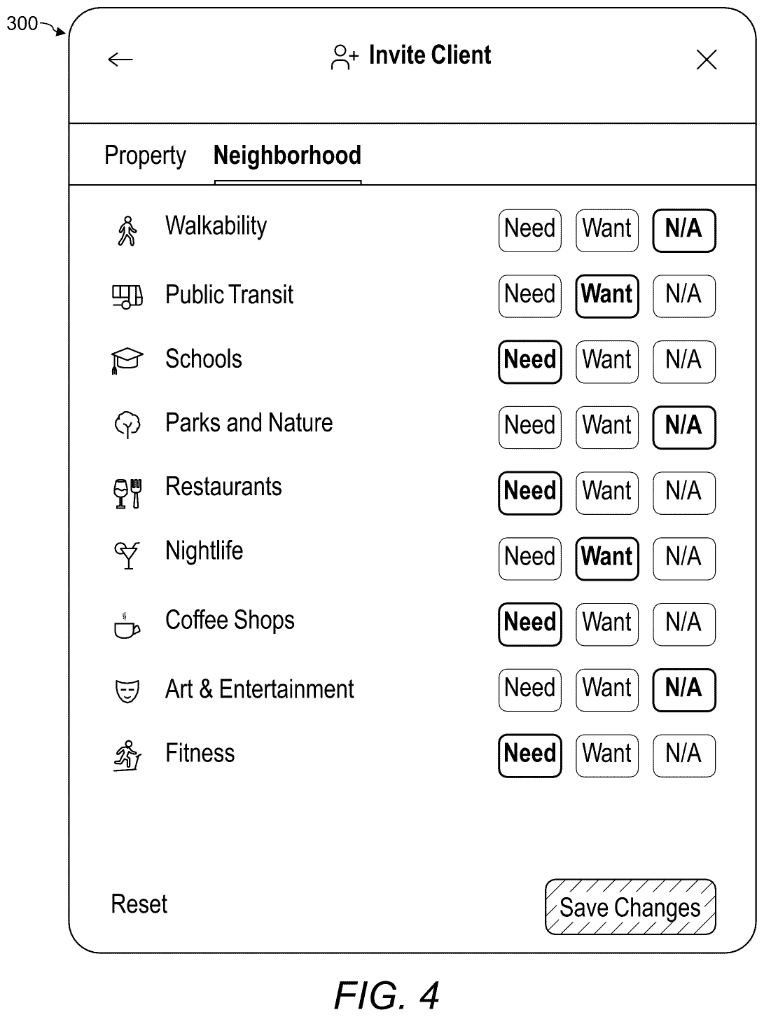

FIGS. 3 and 4 show example user interfaces for designating search criteria, in accordance with representative embodiments. Specifically, the user interfaces 300 may include one or more prompts 302 for a user to designate search criteria 304 (e.g., wish-list criteria), which can be used by a platform according to the present teachings for processing and analyzing in view of real estate data for one or more properties. In particular, these figures show examples of how an agent can designate and/or receive wish-list criteria for a client. It is worth noting that the attributes of the search criteria 304 may change based on particular users, locations, and otherwise, and those shown are provided by way of example.

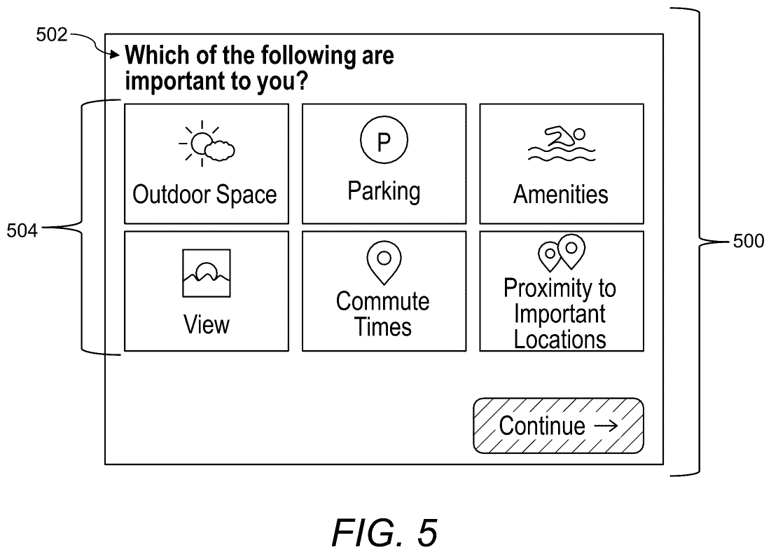

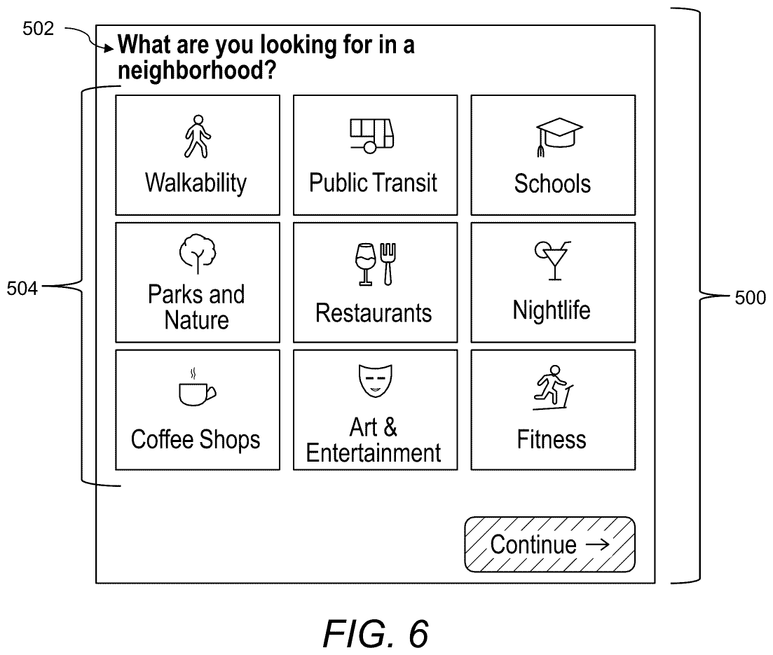

FIGS. 5 and 6 show examples of user interfaces for assisting in creating and processing search criteria, in accordance with a representative embodiment. Specifically, the user interfaces 500 show example prompts 502 (e.g., questions presented to a user) for a user to select certain criteria 504 (e.g., for a user to select certain attributes—where the attributes are related to certain real estate data—as relevant/significant/important to the user). Selection of certain criteria 504 from such prompts 502 may be used for the processing of search criteria, e.g., the weighting and/or buffers related to the same, which can be used for comparison to property profiles and the scoring of one or more properties. That is, FIGS. 5 and 6 may include user interfaces 500 that can be used to assist in creating a wish list, e.g., using an interactive wizard or the like assisting a client in creating their wish list. These figures, and other figures herein, also show techniques for gathering search criteria that can be used to identify a relative importance of criteria for a user, e.g., for creating actionable insights as discussed herein.

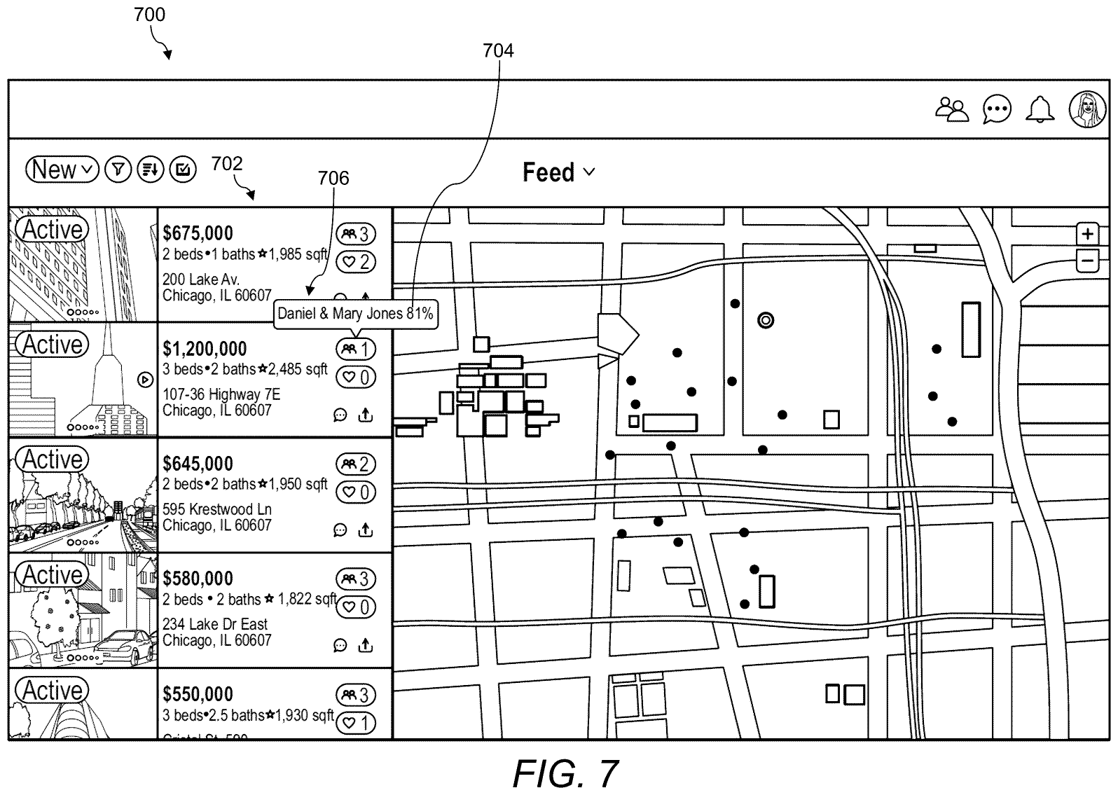

FIG. 7 shows an example user interface with a plurality of listings showing a score, in accordance with a representative embodiment. Specifically, the user interface 700 may include listings 702, where one or more such listings 702 may include a score 704 associated with a user 706. The figure may represent an example user interface 700 for a real estate agent or the like. In particular, the user interface 700 may represent an example of an agent feed, where an operation such as a selection, hover, or the like shows one or more active clients (the user 706 in this example) that a particular property is a match for and what the match percentage (e.g., where this is the score 704 in this example) is for the client(s). This can allow agents to be more precise with regard to the properties that they review and how they allocate their time.

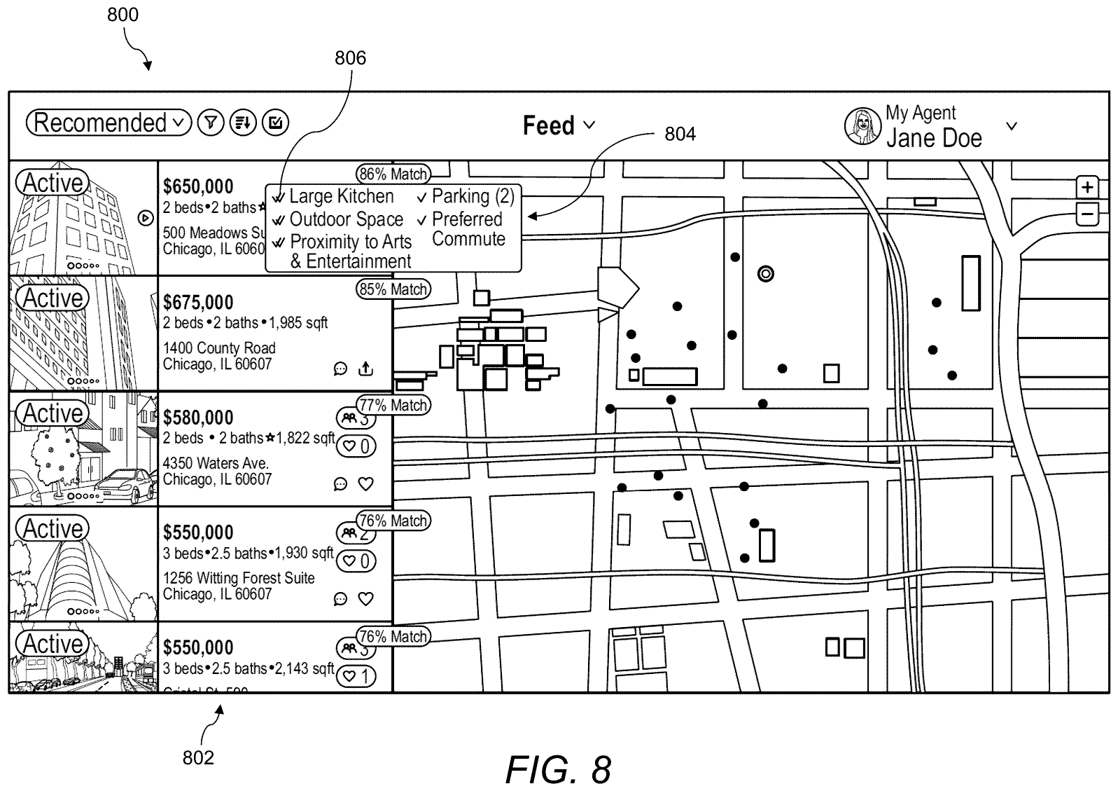

FIG. 8 shows an example user interface with a plurality of listings showing certain attributes, in accordance with a representative embodiment. Specifically, the user interface 800 may include listings 802, where one or more such listings 802 may include attributes 804 thereof with indications 806 related to how a property's attributes from a property profile match certain search criteria that a user has provided. As shown in the figure, the indications 806 may differ to indicate how closely a match the attributes 804 are to certain search criteria, e.g., by including multiple check marks when a close match is present—and where it will be understood that other types of indicators (including other visual identifiers such as symbols, graphs, percentage matches, scores, and the like) are also or instead possible. In this figure, the listings 802 may be ranked by score (where it will be understood that they can be further filtered or sorted differently at a user's discretion). This can allow the present teachings to display the properties most relevant to a user without actually removing properties in the way that traditional filters do. Using a platform according to the present teachings, an action such as a hover or the like can show a quick breakdown of pertinent aspects pertaining to the score—e.g., the attributes 804 with their corresponding indications 806.

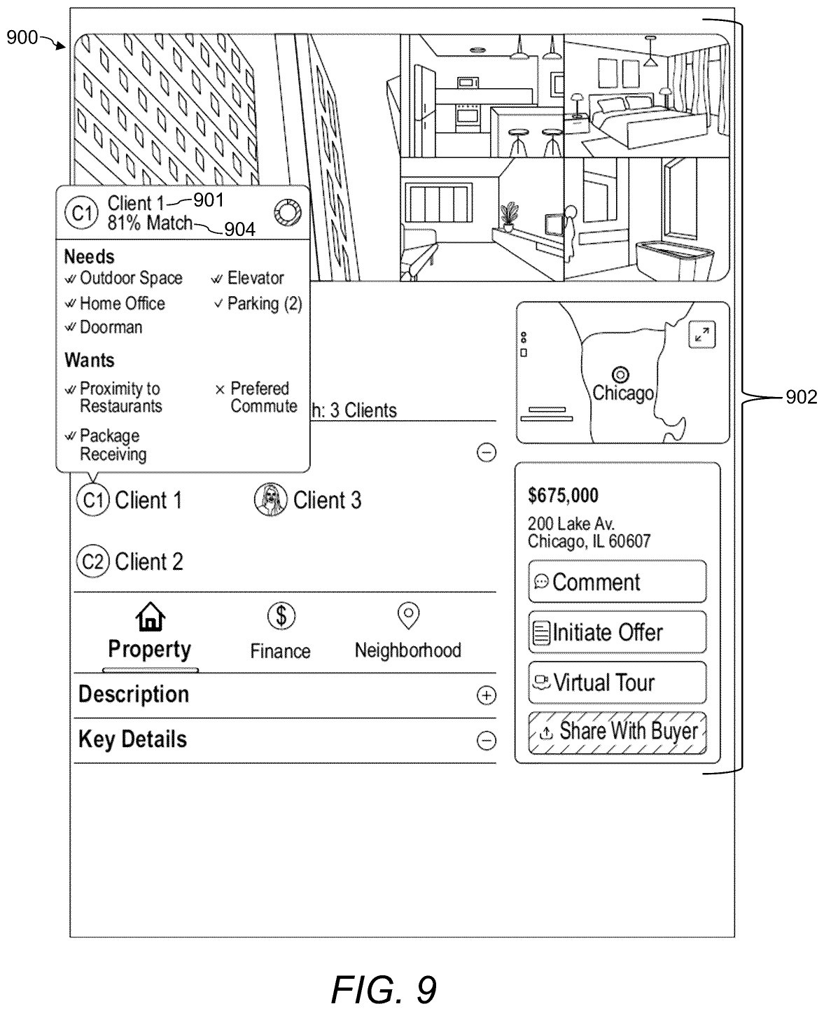

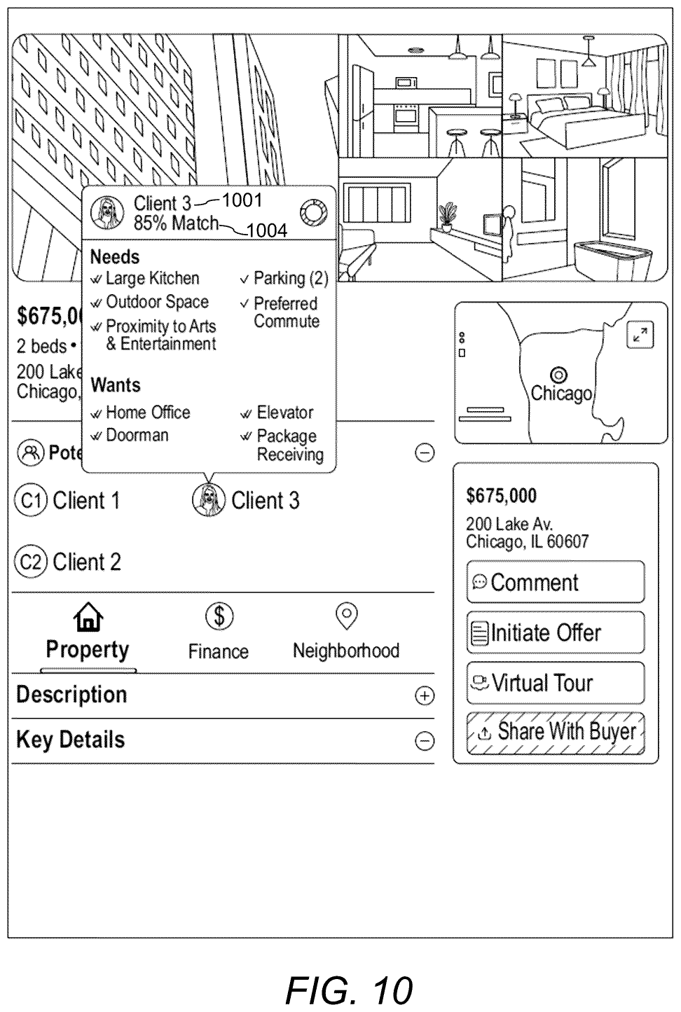

FIGS. 9 and 10 show example user interfaces with a listing showing scores and certain search criteria for different users, in accordance with a representative embodiment. That is, these figures may show an example user interface 900 representing an agent's view of an individual listing 902. As shown in these figures, in some aspects, agents can see which clients 901, 1001 that the property is a match for, as well as displaying the score 904, 1004 and how it breaks down with information related to property attributes corresponding to a client's search criteria.

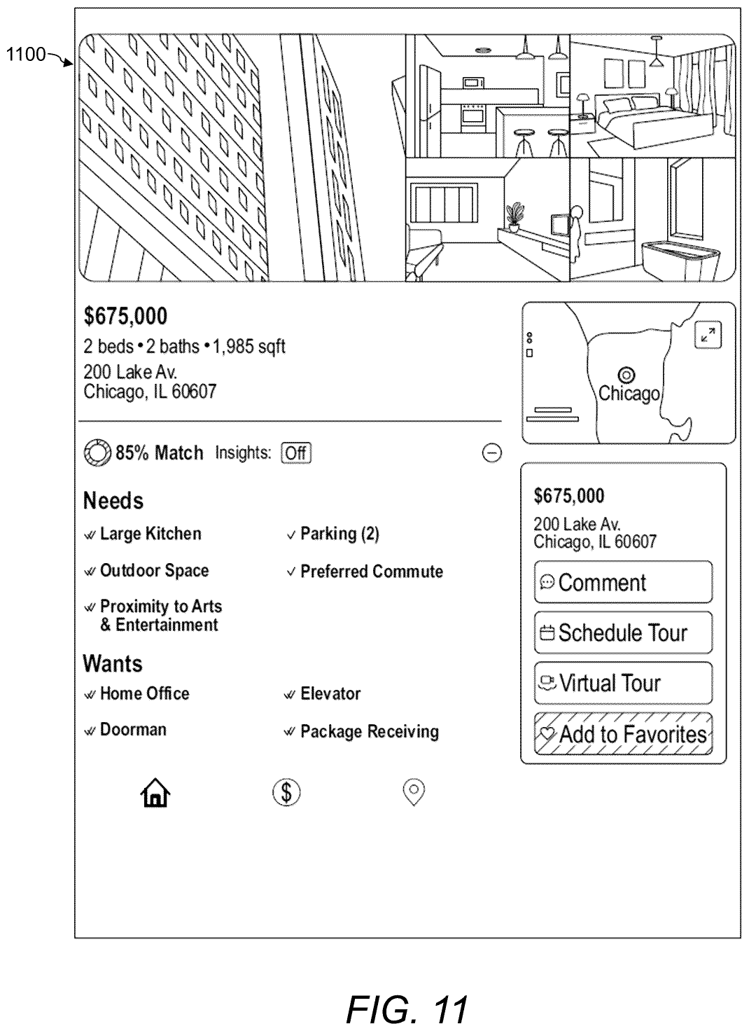

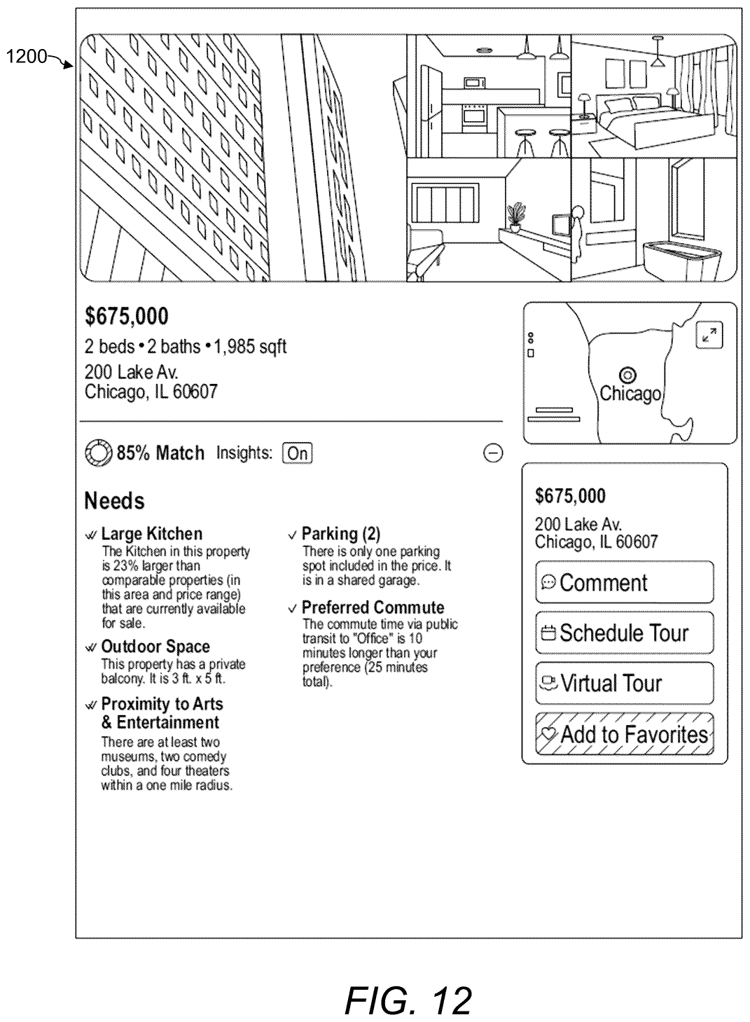

FIG. 11 shows an example user interface with a listing showing a score and certain search criteria for a user, in accordance with a representative embodiment; and FIG. 12 shows an example user interface with a listing showing a score and information related to certain real estate data, in accordance with a representative embodiment. These user interfaces 1100, 1200 may be examples of a client's view of an individual property. For example, as shown in FIG. 11, each property may be displayed in the context of a personalized view for that client, showcasing the factors most important/relevant to them first. The client can then dig-in further if they choose, which is represented in FIG. 12. Specifically, FIG. 12 shows an example of a client view when insights/descriptors are toggled on. These descriptors can provide quick descriptions of the data/logic used so that the client can understand the “why” of the wish-list matches, as well as learn from the information as they search.

### Insights

Through the various modules within a platform according to the present teachings, as well as the collaborative nature of the platform, there may be a number of activities that are tracked in order to give a user (e.g., real estate agents) visibility into their business or otherwise useful insights. In this context, activities can be considered to be actions that are tracked on the platform, which can provide users visibility. Examples of such actions in the context of an agent, include, but are not limited to: when a client creates a new search; when a client adds properties to their favorites list; when a client changes their search criteria; when a client interacts with their homeowner dashboard; when a client responds to a KIT; when a client or collaborator completes a transaction task; when a milestone in a transaction is coming up; and similar. And, in this context, insights can be considered to be inferences and/or patterns drawn from behavioral trends. Thus, providing insights may include a pattern analysis of certain activities.

Activities of interest for insights, such as those listed above, may be displayed in a feed, and the platform may allow for notifications and reports to be created related to these activities. In addition, the platform may use the activities and in-app tracking to search for and identify behavioral patterns.

By way of example: because the relative importance-based searching intakes what is important to a client, the system may compare the properties they are spending the most time interacting with and/or returning to against the stated preferences in their wish list. If there is a mismatch, that can be surfaced to the agent as an insight. To be more specific with this example, if a client says they only want a house in a specific school district where homes in their price range are smaller, but they are spending more time looking at homes outside of that school district that are larger, this can be surfaced to the agent as an insight. And, in this manner, understanding a user's stated wish list/features of importance against actual user behavior, closing data, and the like can provide more accurate measurement of consumer demand.

Another example: if a buyer is closing on their property in 5 days and their search activity spikes, this can be surfaced to the agent as a “cold feet” signal. Because the present teachings may include a platform that has searching and transactions in one place, insights can be obtained where otherwise it would have been difficult, as this is the type of insight to which agents have historically been reactive, instead of proactive.

Another example: if a past client checks a home value related communication every month (or other similar KIT-related communication and the like), that client checking this month, while reported as an activity, may not necessarily be information that will drive a specific action. However, if a client who only checks every quarter is now checking monthly, that can serve as an indicator that they may be thinking about selling. If a client who checks monthly also starts searching for a larger home, that may be an indicator of a trade-up opportunity.

Thus, the present teachings may include reviewing and analyzing not just what users are doing, but how what they are doing may deviate from a preexisting pattern and/or are related to other actions. By identifying and surfacing these signals and cues, agents may be provided with visibility that they do not currently have, thus empowering them to be proactive, and helping drive strategic touch points that are valuable to both parties.

Thus, providing insights may include recognizing patterns of user interaction with a platform and/or deviations from a pattern. To this end, one or more of the following computing tools may be used: web analytics tools (e.g., that track and analyze user interactions on the platform to provide insights into user behavior, such as page views, click-through rates, conversion rates, and user flow), event tracking tools (e.g., tools that collect and analyze specific user actions or events within the platform to understand how users interact with different features and functionalities), heatmap tools, session replay tools, User Behavior Analytics (UBA) tools (e.g., tools that employ machine learning and advanced analytics techniques to detect patterns in user behavior, such as to identify anomalies, detect trends, and segment users based on their interaction patterns), Customer Relationship Management (CRM) tools, and similar.

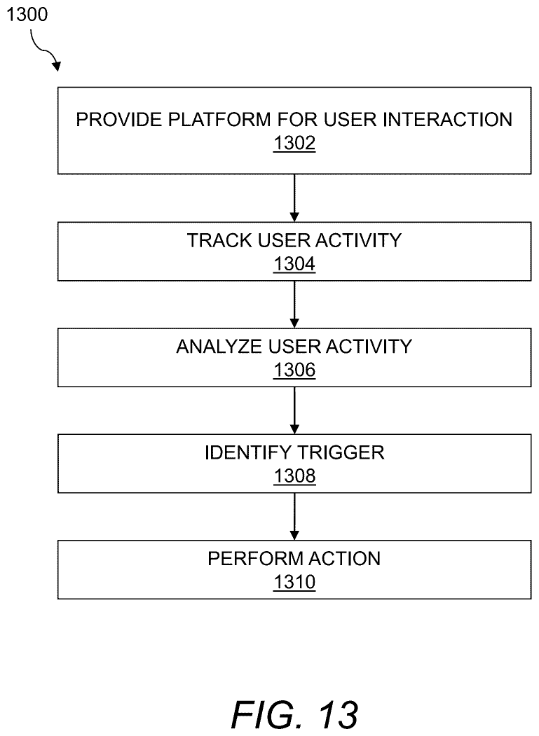

FIG. 13 is a flow chart of a method for analyzing user activity on a platform for obtaining certain insights, in accordance with a representative embodiment. The method 1300 may be performed using a system such as any described herein, e.g., the system 100 of FIG. 1. And, in some aspects, the method 1300 may be performed by a computer program product comprising computer executable code embodied in a non-transitory computer readable medium that, when executing on one or more computing devices, performs one or more of the steps of the method 1300. The method 1300 may generally recite a technique for providing insights based on user activity on a platform according to the present teachings.

As shown in step 1302, the method 1300 may include providing a platform for user interaction with one or more of the following: search criteria, property profiles, property listings, transaction documents, property valuations, and the like. The platform may be the same or similar to any as described and shown herein.

As shown in step 1304, the method 1300 may include tracking user activity by a user of the platform. The user may include an individual interested in real estate such as a client of a real estate agent, an investor, a real estate professional (e.g., an agent), and the like.

As shown in step 1306, the method 1300 may include analyzing the user activity. In general, such an analysis may be performed using a model (e.g., a machine learning model or similar). For example, the method 1300 may utilize a machine learning model that at least in part includes a user behavior analytics tool. The user activity may be analyzed to identify one or more triggers in activity, and as shown in step 1308, the method 1300 may include identifying such a trigger. By way of example, the analysis may include identifying a pattern of user activity by the user, associating the pattern with the user, and identifying a deviation in the pattern. The deviation may represent the trigger that is identified. Analyzing the user activity may also or instead include comparing user interactions with expected interactions, and identifying a discrepancy related thereto—e.g., where the discrepancy represents the trigger that is identified.

Triggers may include one or more of a variety of activities, actions, patterns, deviations from existing or expected behaviors or patterns, and the like. For example, triggers in activity may include one or more of the following: a search, interaction with a property listing, a change in a search criterion, interaction with a certain portion of the platform, a response to a prompt, completion of a transaction task, timing of a search relative to a predetermined milestone, interaction with a property valuation, and the like. A trigger may also or instead include a discrepancy between user interactions with expected interactions. A trigger may also or instead may be related to a threshold corresponding to one or more of: page views, click-through rates, conversion rates, user flow, and the like.

As shown in step 1310, the method 1300 may include, in response to identifying one or more triggers in activity, performing an action. By way of example, this may include transmitting a notification to one or more computing devices such as a computing device associated with a real estate professional, a computing device associated with the user, and so on. In some aspects, the notification includes, or is accompanied by, a report or the like with information related to the activity, the trigger, and so on. The action may also or instead include segmenting the user into a group of users based on the user activity. Other actions are also or instead possible.

Other insights are also or instead possible. For example, user activity may be evaluated in view of a property that is eventually purchased by a user, and/or in view of one or more properties that a user considered, ignored, viewed, otherwise engaged with, etc. That is, in certain aspects, the search criteria (and/or subsets thereof, such as the primary and secondary criteria discussed herein) may be compared to property attributes in the property profile of the listing that a user engaged with—e.g., purchased and/or viewed—and/or chose not to engage with. This analysis can be helpful to, e.g., adjust how the weighting is performed, adjust one or more buffer thresholds assigned to search criteria, adjust scoring and/or ranking, adjust displays, adjust property profiles, adjust marketing touches and techniques, take other actions, and so forth. That is, such an analysis may be used to adjust the relative importance of certain attributes/criteria for a user, which in turn can be used for similar users (e.g., users having similar demographics and/or budget, users in similar areas, users with similar wants/needs, and the like) and/or similar properties. Such an analysis may also or instead be used to identify trends in the relative importance and/or popularity (or lack thereof) of certain property attributes. And in turn, actions such as adjusting property descriptions, prices, recommendations, scores, and the like may be performed in light of this analysis.

Therefore, the present teachings may include a correlation of insights with an understanding relative importance in users' searches. That is, using relative importance of search input such as from the searching described herein, an understanding can be made regarding not just what a user is looking for, but the relative importance of certain items to the user, and this can be used to draw insights, e.g., regarding demand for certain property features. That is, the present teachings can including comparing stated behavior to actual behavior—e.g., what properties did a user view, show interest in, purchase, etc., relative to what they said was important. This can also or instead be used to determine actual demand versus stated or perceived demand, and to determine what property features people are willing to compromise on or not. In this manner, the present teachings can be used to provide more accurate pricing analysis—e.g., what features truly increase the value of a property, and by how much. The present teachings can also or instead be used to provide more accurate estimated property/home values, estimated rental values, resale potential, inform new construction and/or renovation decisions, and the like. Drawing from the other modules of the present teachings, insights can also or instead be made for things such as a likelihood to close on a deal.

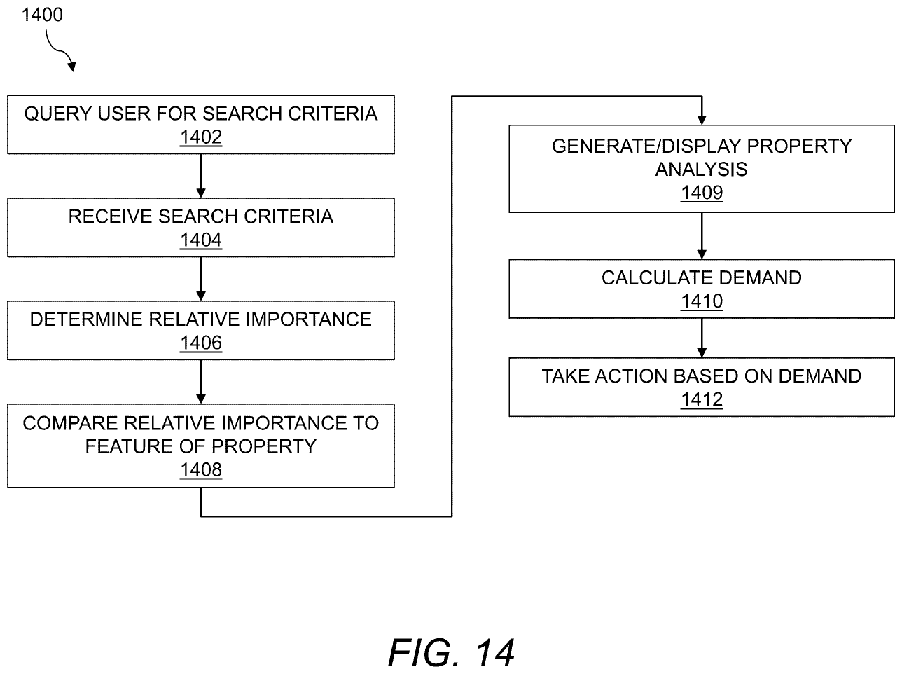

FIG. 14 is a flow chart of a method for using a platform for obtaining certain insights, in accordance with a representative embodiment. The method 1400 may be performed using a system such as any described herein, e.g., the system 100 of FIG. 1. And, in some aspects, the method 1400 may be performed by a computer program product comprising computer executable code embodied in a non-transitory computer readable medium that, when executing on one or more computing devices, performs one or more of the steps of the method 1400. In general, the method 1400 may include using a relative importance of certain features for users to draw insights useful in a platform or system such as any as described herein. In certain aspects, the method 1400 may be used to determine what features are important to a user or group of users (and/or which features are less important), analyze expected versus actual behavior, determine demand, adjust pricing or marketing, adjust searching, identify likely compromises (or lack thereof), and so forth.

As shown in step 1402, the method 1400 may include querying a user for search criteria on a user device via a computing platform. The queries, search criteria, user device, and computing platform may be any as described herein.

As shown in step 1404, the method 1400 may include receiving the search criteria from the user. This may include any of the techniques described herein, e.g., with respect to step 208 of FIG. 2 described above.

As shown in step 1406, the method 1400 may include processing the search criteria to determine a relative importance of at least one criterion included in the search criteria. This may include an analysis of answers provided by a user to one or more prompts, e.g., in some instances including express input from a user regarding a perceived importance of one or more features related to a property.

As shown in step 1408, the method 1400 may include comparing, using a computer model (e.g., a machine learning model), the relative importance of at least one criterion to features of one or more properties of interest for the user. In some aspects, one or more properties of interest for the user may include a property that the user viewed on the computing platform. One or more properties of interest for the user may also or instead include a property that the user purchased, or made an offer to purchase, or otherwise expressed interest in. Conversely, this may include properties that a user ignored or otherwise chose not to engage with. This may also or instead include properties that a user provided feedback for, whether positive, neutral, or negative.

As shown in step 1409, the method 1400 may include generating, and in some instances displaying, a property analysis. The property analysis may include an evaluation (e.g., scoring, ranking, etc.) of one or more properties based on the relative importance of at least one criterion to features of these one or more properties for the user, and/or descriptions that identify and elaborate upon features of interest for the user based on a known relative importance thereof. In other words, the property analysis may provide a personalized experience for the user, where a certain property is described and shown with an emphasis on features that are relatively important to the user. The property analysis may thus provide a breakdown of features that a property includes and/or lacks, with such a breakdown customized by relative importance to a particular user deduced from search criteria. Such a personalized property analysis may thus be particularly advantageous given the extensive financial and emotional commitment that goes into buying a property—e.g., by clearly demonstrating how a property is suitable or unsuitable for a particular user. Such a personalized property analysis may also or instead be utilized to hedge the risk that a property may not be suitable for a particular user—e.g., by providing a customized summary of the property that includes particular attributes deemed to be relatively important (or unimportant) for the particular user. Thus, the property analysis may be a product of the various techniques described herein (e.g., weighting and/or buffer application), which are used to provide personalized property analyses for users such as real estate agents and their clients.

As shown in step 1410, the method 1400 may include, calculating, based on the comparison (e.g., using the same computer model or a different model), demand for one or more features corresponding to the criterion. The calculated demand may be based on a plurality of comparisons of relative importance to features of one or more properties from a plurality of users. That is, a plurality of users may be used to determine demand for certain features.

As shown in step 1412, the method 1400 may include taking an action related to the calculated demand for one or more features. By way of example, the action may include one or more of the following or similar: adjusting a price of a property including one or more features (and/or making a recommendation regarding a pricing adjustment, e.g., if it is determined through a calculated demand that a price listing should be higher or lower than a current price; this can also or instead include an investment analysis when a price is deemed to be too high or too low, and/or adjusting valuation calculations/potential price); adjusting a weighting of one or more features used for searching a plurality of properties; calculating a likelihood of purchasing one or more properties including one or more features; determining whether one or more features corresponding to the at least one criterion constituted a tradeoff made by the user; and so forth. In certain aspects, the action includes generating one or more of a notification and a report, e.g., a report that includes information related to a tradeoff made by the user.

Other features that may be included in a platform according to the present teachings include reverse prospecting, demand testing, and value and market analysis, where each is explained below.

Reverse prospecting may include providing agents with tools to find prospective buyers. That is, because of the granularity that the platform may have for a buyer's specific preferences, that information can be used to enable agents to quickly find the right buyers and make deals faster.

Demand testing can be related to a user's or set of users' wish lists, where the platform may measure and test demand for a specific property before it comes on the market based on the property's attributes beyond just location, price, and size, which most available demand testing mechanisms are currently limited to.

Value and market analysis may utilize the granular buyer preference data that the platform collects, where the platform can more accurately assess the potential value of home updates, as well as provide even more accurate price estimates beyond what current market models allow for.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionalities may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared, or other device or combination of devices. In another aspect, any of the systems and methods described above may be embodied in any suitable transmission or propagation medium carrying computer-executable code and/or any inputs or outputs from same.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings.

Unless the context clearly requires otherwise, throughout the description, the words “comprise,” “comprising,” “include,” “including,” and the like are to be construed in an inclusive sense as opposed to an exclusive or exhaustive sense; that is to say, in a sense of “including, but not limited to.” Additionally, the words “herein,” “hereunder,” “above,” “below,” and words of similar import refer to this application as a whole and not to any particular portions of this application.

It will be appreciated that the devices, systems, and methods described above are set forth by way of example and not of limitation. For example, regarding the methods provided above, absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y, and Z may include any method of directing or controlling any combination of such other individuals or resources to perform steps X, Y, and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

While particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A computer program product comprising computer executable code embodied in a non-transitory computer readable medium that, when executing on one or more computing devices, performs the steps of:
receiving real estate data for a plurality of properties from one or more third-party sources of data;
processing the real estate data including at least one of normalizing the real estate data and tagging the real estate data to create a property profile for each listing included in the real estate data;
receiving search criteria from a user;
processing the search criteria including (i) weighting at least a portion of the search criteria, and (ii) assigning a buffer threshold to at least one criterion of the search criteria;
analyzing, using a model, the processed real estate data by comparing the property profiles for one or more properties to the processed search criteria;
scoring the one or more properties based on at least (i) a match between processed real estate data and the processed search criteria, the match at least in part accounting for the buffer threshold of the at least one criterion, and (ii) weighting of the processed search criteria;
ranking the one or more properties based on the scoring; and
displaying, on a user interface, at least a portion of the ranking of the one or more properties.

2. The computer program product of claim 1, wherein all properties within buffer thresholds are scored.

3. The computer program product of claim 2, further comprising computer executable code that, when executing on the one or more computing devices, performs the step of displaying at least one listing having a parameter falling outside of the search criteria but within one or more buffer thresholds.

4. The computer program product of claim 1, wherein weighting at least the portion of the search criteria is based at least in part on user input.

5. The computer program product of claim 4, wherein the user input includes an identification of importance that affects the weighting.

6. The computer program product of claim 4, wherein the user input includes user interactions that are evaluated to deduce one or more indications of importance that affect the weighting.

7. The computer program product of claim 1, wherein processing the search criteria accounts for location.

8. The computer program product of claim 1, wherein the search criteria is received from prompts provided to a user on the user interface.

9. The computer program product of claim 1, wherein the scoring of the one or more properties includes:
assigning a full value of weighted points when there is a complete match between processed real estate data and a criterion of the processed search criteria;
assigning a partial value of weighted points when there is a partial match between processed real estate data and the criterion of the processed search criteria;
assigning no weighted points when there is no match between processed real estate data and the criterion of the processed search criteria; and
summing values of weighted points to generate at least a portion of a score.

10. The computer program product of claim 1, further comprising computer executable code that, when executing on the one or more computing devices, performs the step of displaying a score for each of the one or more properties.

11. The computer program product of claim 1, further comprising computer executable code that, when executing on the one or more computing devices, performs the step of displaying information related to real estate data for the one or more properties corresponding to at least a portion of the processed search criteria.

12. The computer program product of claim 1, further comprising computer executable code that, when executing on the one or more computing devices, performs the step of providing a personalized view of the ranking of the one or more properties.

13. The computer program product of claim 12, wherein the personalized view includes identification of certain search criteria compared to one or more attributes of the one or more properties.

14. The computer program product of claim 12, wherein the personalized view includes a description related to the ranking.

15. The computer program product of claim 1, further comprising computer executable code that, when executing on the one or more computing devices, performs the step of updating the real estate data automatically on a periodic basis.

16. The computer program product of claim 1, wherein the real estate data is retrieved from at least two sources, and wherein the computer program product further comprises computer executable code that, when executing on the one or more computing devices, performs the step of prioritizing the real estate data based on a source of the at least two sources.

17. The computer program product of claim 1, wherein the real estate data includes at least one of: an image, neighborhood information, geospatial data, government data, a map, school data, and a satellite image.

18. The computer program product of claim 1, wherein the model is a machine learning model.

19. A method, comprising:
receiving real estate data for a plurality of properties from one or more third-party sources of data;
processing the real estate data including at least one of normalizing the real estate data and tagging the real estate data to create a property profile for each listing included in the real estate data;
receiving search criteria from a user, the search criteria including and characterized by primary criteria and secondary criteria;
processing the search criteria including (i) weighting at least a portion of each of the primary criteria and the secondary criteria, and (ii) assigning a buffer threshold to at least one criterion of one or more of the primary criteria and the secondary criteria;
analyzing, using a model, the processed real estate data by comparing the property profiles for one or more properties to the processed search criteria;
scoring the one or more properties based on at least (i) a match between processed real estate data and the processed search criteria, the match at least in part accounting for the buffer threshold of the at least one criterion, and (ii) weighting of the processed search criteria;
ranking the one or more properties based on the scoring; and
displaying, on a user interface, at least a portion of the ranking of the one or more properties.

20. A system, comprising:
a data network;
a plurality of processors coupled to the data network; and
a remote computing resource coupled to the data network, the remote computing resource including a processor and a memory, the memory storing code executable by the processor to perform the steps of:
receiving real estate data for a plurality of properties from one or more third-party sources of data;
processing the real estate data including at least one of normalizing the real estate data and tagging the real estate data to create a property profile for each listing included in the real estate data;
receiving search criteria from a user;
processing the search criteria including (i) weighting at least a portion of the search criteria, and (ii) assigning a buffer threshold to at least one criterion of the search criteria;
analyzing, using a model, the processed real estate data by comparing the property profiles for one or more properties to the processed search criteria;
scoring the one or more properties based on at least (i) a match between processed real estate data and the processed search criteria, the match at least in part accounting for the buffer threshold of the at least one criterion, and (ii) weighting of the processed search criteria;
ranking the one or more properties based on the scoring; and
displaying, on a user interface, at least a portion of the ranking of the one or more properties.
